(19) United States
(12) Patent Application Publication
(10) Pub. No.: US 2011/0157130 A1
(43) Pub. Date: Jun. 30, 2011

(54) DRIVING METHOD OF ELECTRO OPTICAL DEVICE, DRIVING DEVICE OF ELECTRO OPTICAL DEVICE, ELECTRO OPTICAL DEVICE, AND ELECTRONIC INSTRUMENT

(75) Inventor: Tadashi Yasue, Suwa-shi (JP)

(73) Assignee: SEIKO EPSON CORPORATION, Tokyo (JP)

(21) Appl. No.: 12/975,907

(22) Filed: Dec. 22, 2010

(30) Foreign Application Priority Data
Dec. 28, 2009 (JP) 2009-297050

(51) Int. Cl. G09G 3/36; G06F 3/038

(52) U.S. Cl. 345/211; 345/98

(57) ABSTRACT

A driving method of an electro optical device for driving with an Multi Line Selection driving method includes a gradation parameter assigning step of assigning display data of N bits (N is an integer equal to or larger than two) to a gradation parameter of M bits (N<M, M is an integer equal to or larger than three), and a driving step of applying a driving voltage in accordance with an Frame Rate Control pattern selected on the basis of the gradation parameter to the segment electrodes in a divided period in association with the gradation parameter assigned at the gradation parameter assigning step out of periods provided by dividing a selection period of common electrodes simultaneously selected.

The entire disclosure of Japanese Patent Application No. 2009-297050, filed Dec. 28, 2009, is expressly incorporated by reference herein.

### BACKGROUND

1. Technical Field

An aspect of the present invention relates to a driving method of an electro optical device, a driving device of an electro optical device, an electro optical device, an electronic instrument.

2. Related Art

As a gradation display method in an electro optical device typified by a liquid crystal display device which employs a liquid crystal element as an electro optical element, a gradation display method with a Frame Rate Control (hereinafter abbreviated as FRC) scheme, a gradation display method with a Pulse Width Modulation (hereinafter abbreviated as PWM) scheme and the like are known. The FRC scheme is a scheme in which gradation display is performed by thinning out frames of a plurality of frames, and the PWM scheme is a scheme in which gradation display is performed by adjusting a period over which a driving voltage is applied.

In driving the liquid crystal display device of a simple matrix type with a Multi Line Selection (hereinafter abbreviated as MLS) driving method, the gradation display is performed in the FRC scheme or the PWM scheme to allow the display of images having favorable contrast. For example, WO 00/02185 (Patent Document 1) and JP-A-2002-149131 (Patent Document 2) have disclosed a technology for performing the gradation display with the PWM scheme in the liquid crystal driving with the MLS driving method. JP-A-9-218385 (Patent Document 3) has disclosed a technology for performing the gradation display with the FRC scheme in the liquid crystal driving with the MLS driving method. In addition, JP-A-10-104575 (Patent Document 4) has disclosed a point for performing the gradation display with the PWM scheme or the FRC scheme in the liquid crystal driving with the MLS driving method. Furthermore, JP-A-2003-84732 (Patent Document 5) has disclosed a technology for performing the gradation display with a combination of the PWM scheme and the FRC scheme in the liquid crystal display with the MLS driving method.

Patent Document 1 to Patent Document 4, however, have only disclosed the technologies for performing the gradation display with the PWM scheme or the FRC scheme in the liquid crystal driving with the MLS driving method. Thus, even when the PWM scheme and the FRC scheme disclosed in Patent Document 1 to Patent Document 4 are simply combined to perform the liquid crystal driving with the MLS driving method, the combinations of the settings of the PWM scheme and the settings of the FRC scheme are limited, and concentration settings for halftones are restricted.

In Patent Document 5, for example in combining the FRC scheme with the PWM scheme in four frames, three of the frames are assigned to the FRC scheme and the remaining one frame is assigned to the PWM scheme. Similarly, for example in combining the FRC scheme with the PWM scheme in five frames, four of the frames are assigned to the FRC scheme and the remaining one frame is assigned to the PWM scheme. However, the gradations assigned to the FRC scheme are only 0 (= 0/4), 1/4, 2/4, 3/4, and 1 (= 4/4), and it is impossible to assign such gradations as ⅓ and ⅔, for example. This is because the frame assigned to the PWM scheme is fixed in the series of frames in the technology disclosed in Patent Document 5 and thus the gradations with a different number of frames cannot be assigned in the FRC scheme. As a result, Patent Document 5 has the problem in which the number of the gradations assigned to the FRC scheme is limited to restrict the concentration settings for the halftones.

### SUMMARY

The present invention has been made in view of the technological problem as described above. According to some aspects of the present invention, it is possible to provide a driving method of an electro optical device, a driving device of an electro optical device, an electro optical device, an electronic instrument and the like in which the degree of flexibility in the concentration settings for halftones is improved in performing the gradation display with the PWM scheme and the FRC scheme.

(1) In an aspect of the present invention, a driving method of an electro optical device of driving an electro optical device having a plurality of common electrodes and a plurality of segment electrodes intersecting each other with a Multi Line Selection (hereinafter abbreviated as MLS) driving method includes a gradation parameter assigning step of assigning display data of N bits (N is an integer equal to or larger than two) in association with each dot provided in an intersecting region of each of the common electrodes and each of the segment electrodes to a gradation parameter of M bits (N<M, M is an integer equal to or larger than three), and a driving step of applying a driving voltage in accordance with a result of MLS computing on a display pattern indicated by a Frame Rate Control (hereinafter abbreviated as FRC) pattern selected on the basis of part of the gradation parameter to the plurality of segment electrodes in a divided period in association with at least part of the gradation parameter assigned at the gradation parameter assigning step out of a plurality of divided periods provided by dividing a sub-selection period provided by dividing a selection period of a plurality of common electrodes simultaneously selected.

In the present aspect, the display data of N bits per dot is assigned to the gradation parameter of M bits, and the driving voltage in accordance with the result of MLS computing on the display pattern indicated by the FRC pattern selected on the basis of part of the gradation parameter is applied to the plurality of segment electrodes in the divided period of the PWM in association with at least part of the gradation parameter. As a result, selection can be made from the plurality of divided periods and the selected divided period may be used to allow the PWM regardless of the original display data. Thus, through the combination with the FRC scheme, the PWM scheme and the FRC scheme can be combined within the same frame in the MLS driving to improve the degree of flexibility in the concentration settings for halftones.

(2) In the driving method of the electro optical device according to another aspect of the present invention, the driving step includes a first divided period driving step of applying a driving voltage in accordance with a result of MLS computing on a display pattern indicated by a first Frame Rate Control (hereinafter abbreviated as FRC) pattern selected on the basis of part of the gradation parameter to the plurality of segment electrodes in a first divided period in association with part of the gradation parameter assigned at the gradation parameter assigning step out of the plurality of divided periods, and a second divided period driving step of applying a driving voltage in accordance with a result of MLS computing on a display pattern indicated by a second FRC pattern selected on the basis of part of the gradation parameter to the plurality of segment electrodes in a second divided period in association with part of the gradation parameter assigned at the gradation parameter assigning step out of the plurality of divided periods.

In the present aspect, the driving voltage in accordance with the result of MLS computing on the display pattern indicated by the first FRC pattern selected on the basis of the gradation parameter is applied in the first divided period specified by the gradation parameter out of the plurality of divided periods provided by dividing each sub-selection period. In addition, the driving voltage in accordance with the result of MLS computing on the display pattern indicated by the second FRC pattern selected on the basis of the gradation parameter is applied in the second divided period specified by the gradation parameter. Thus, the gradation display can be performed by using an arbitrary FRC pattern in an arbitrary divided period with the PWM regardless of the display data.

(3) In the driving method of the electro optical device according to another aspect of the present invention, the first divided period or the second divided period is selected on the basis of a higher-order bit of the gradation parameter.

According to the present aspect, in addition to the abovementioned advantages, an arbitrary divided period with the PWM can be selected on the basis of the gradation parameter.

(4) In the driving method of the electro optical device according to another aspect of the present invention, a driving voltage in accordance with a result of MLS computing on a display pattern indicated by an FRC pattern selected on the basis of a lower-order bit of the gradation parameter is applied to the plurality of segment electrodes.

According to the present aspect, in addition to the abovementioned advantages, an arbitrary FRC pattern can be easily selected on the basis of the gradation pattern.

(5) In the driving method of the electro optical device according to another aspect of the present invention, one of the first divided period or the second divided period provided by dividing the sub-selection period into two is selected on the basis of higher-order two bits of the gradation parameter.

According to the present aspect, an arbitrary divided period of the PWM can be selected on the basis of the gradation parameter in performing the gradation display with the simple PWM in which the sub-selection period is divided into two.

(6) In the driving method of the electro optical device according to another aspect of the present invention, the first divided period and the second divided period can be switched within the sub-selection period.

According to the present aspect, in addition to the abovementioned advantages, randomization can be performed easily, and the display quality of the gradation display can be improved.

(7) In the driving method of the electro optical device according to another aspect of the present invention, the order of the first divided period and the second divided period within the sub-selection period is set to be reversed for each segment output.

According to the present aspect, in addition to the abovementioned advantages, the randomization can be performed easily, and the display quality of the gradation display can be improved.

(8) In the driving method of the electro optical device according to another aspect of the present invention, the order of the first divided period and the second divided period is changed for each predetermined period.

According to the present aspect, in addition to the abovementioned advantages, the randomization can be performed easily, and the display quality of the gradation display can be improved.

(9) In another aspect of the present invention, a driving method of an electro optical device of driving an electro optical device having a plurality of common electrodes and a plurality of segment electrodes intersecting each other with a Multi Line Selection (hereinafter abbreviated as MLS) driving method includes a gradation parameter assigning step of assigning display data of N bits (N is an integer equal to or larger than two) in association with each dot provided in an intersecting region of each of the common electrodes and each of the segment electrodes to a gradation parameter of M bits (N<M, M is an integer equal to or larger than three), and a driving step of applying a driving voltage in accordance with a result of MLS computing on a signal subjected to gradation processing with Pulse Width Modulation (hereinafter abbreviated as PWM) and Frame Rate Control (hereinafter abbreviated as FRC) on the basis of part of the gradation parameter to the plurality of segment electrodes in a sub-selection period provided by dividing a selection period of a plurality of common electrodes simultaneously selected.

In the present aspect, the display data of N bits per dot is assigned to the gradation parameter of M bits, and the driving voltage in accordance with the result of MLS computing on the display pattern indicated by the FRC pattern selected on the basis of part of the gradation parameter is applied to the plurality of segment electrodes in the divided period of the PWM in association with at least part of the gradation parameter. As a result, selection can be made from the plurality of divided periods and the selected divided period may be used to allow the PWM regardless of the original display data. Thus, through the combination with the FRC scheme, the PWM scheme and the FRC scheme can be combined within the same frame in the MLS driving to improve the degree of flexibility in the concentration settings for halftones.

(10) In the driving method of the electro optical device according to another aspect of the present invention, the driving step includes a PWM decode step of selecting a divided period in association with at least part of the gradation parameter assigned at the gradation parameter assigning step out of a plurality of divided periods provided by dividing the sub-selection period, an FRC decode step of producing FRC data based on an FRC pattern selected on the basis of part of the gradation parameter, and an MLS decode step of performing given MLS computing on the FRC data produced at the FRC decode step in the divided period selected at the PWM decode step, and a driving voltage in accordance with a result of the MLS computing at the MLS decode step is applied to the plurality of segment electrodes.

According to the present aspect, after the assignment to the gradation parameter, the PWM decode, the FRC decode, and the MLS decode are performed in order. Thus, the PWM scheme and the FRC scheme can be combined within the same frame through simple processing in the MLS driving. As a result, the degree of flexibility in the concentration settings for halftones can be improved.

(11) In the driving method of the electro optical device according to another aspect of the present invention, the electro optical device is a liquid crystal display device.

According to the preset aspect, the gradation display with the PWM scheme and the FRC scheme is performed within the same frame, so that the driving method of the liquid crystal display device can be provided in which the degree of flexibility in the concentration settings for halftones can be improved.

(12) In another aspect of the present invention, a driving device of an electro optical device of driving an electro optical device having a plurality of common electrodes and a plurality of segment electrodes intersecting each other with a Multi Line Selection (hereinafter abbreviated as MLS) driving method includes a gradation parameter assigning portion assigning display data of N bits (N is an integer equal to or larger than two) in association with each dot provided in an intersecting region of each of the common electrodes and each of the segment electrodes to a gradation parameter of M bits (N<M, M is an integer equal to or larger than three), a Pulse Width Modulation (hereinafter abbreviated as PWM) decoder selecting a divided period in association with at least part of the gradation parameter assigned by the gradation parameter assigning portion out of a plurality of divided periods provided by dividing a sub-selection period provided by dividing a selection period of a plurality of common electrodes simultaneously selected, a Frame Rate Control (hereinafter abbreviated as FRC) decoder producing FRC data based on an FRC pattern selected on the basis of part of the gradation parameter in the divided period selected by the PWM decoder, an MLS decoder performing given MLS computing on the FRC data produced by the FRC decoder in the divided period selected by the PWM decoder, and a driving portion applying a driving voltage in accordance with a result of the MLS computing performed by the MLS decoder to the plurality of segment electrodes.

According to the present aspect, the display data of N bits per dot is assigned to the gradation parameter of M bits, and the driving voltage in accordance with the result of MLS computing on the display pattern indicated by the FRC pattern selected on the basis of part of the gradation parameter is applied to the plurality of segment electrodes in the divided period in association with at least part of the gradation parameter. As a result, selection can be made from the plurality of divided periods and the selected divided period may be used to allow the PWM regardless of the original display data. Thus, the driving device of the electro optical device can be provided in which, through the combination with the FRC scheme, the PWM scheme and the FRC scheme can be combined within the same frame in the MLS driving to improve the degree of flexibility in the concentration settings for halftones.

(13) The driving device of the electro optical device according to another aspect of the present invention includes a first output data latch latching the FRC data in a first divided period selected by the PWM decoder out of the plurality of periods, a second output data latch latching the FRC data in a second divided period selected by the PWM decoder out of the plurality of periods, and an output selection circuit outputting a signal latched in the first output data latch or a signal latched in the second output data latch to the driving portion.

According to the present aspect, in addition to the abovementioned advantages, the driving device of the electro optical device can be provided in which the randomization can be performed easily with the simple configuration and the display quality of the gradation display can be improved.

(14) In another aspect of the present invention, an electro optical device includes the driving device described above.

According to the present aspect, it is possible to provide the electro optical device in which the driving device is applied in which the gradation display with the PWM scheme and the FRC scheme is performed within the same frame to improve the degree of flexibility in the concentration settings for halftones.

(15) In another aspect of the present invention, an electronic instrument includes the driving device described above.

According to the present aspect, it is possible to provide the electric instrument in which the driving device is applied in which the gradation display with the PWM scheme and the FRC scheme is performed within the same frame to improve the degree of flexibility in the concentration settings for halftones.

### BRIEF DESCRIPTION OF THE DRAWINGS

FIG. 1 shows an block diagram of a configuration example of an electronic instrument to which an electro optical device according to one embodiment of the present invention is applied.

FIG. 2 shows an explanatory diagram of the principles of a MLS driving method.

FIG. 3 shows a diagram showing the relationship of seven levels of voltage when a liquid crystal display panel is driven with the MLS driving method of four-line simultaneous selection.

FIG. 4 shows a diagram showing an example of a selection pattern when the MLS driving method of the four-line simultaneous selection is performed.

FIG. 5 shows a diagram showing an example of a flow of a gradation display method in a liquid crystal driving device.

FIG. 6 shows an explanatory diagram of a liquid crystal driving method with the liquid crystal driving device in the present embodiment.

FIG. 7 shows an example of display data in the present embodiment.

FIG. 8(A), FIG. 8(B), FIG. 8(C), and FIG. 8(D) show explanatory diagrams of PWM data in association with the display data.

FIG. 9(A), FIG. 9(B) show explanatory diagrams of PWM data at an even-numbered terminal and an odd-numbered terminal of a segment output.

FIG. 10(A), FIG. 10(B) show diagrams showing an example of the PWM data in a fifth frame.

FIG. 11(A), FIG. 11(B) show diagrams showing an example of an FRC pattern in the present embodiment.

FIG. 12(A), FIG. 12(B) show diagrams showing an example of FRC data in association with the FRC pattern selected on the basis of display data.

FIG. 13(A), FIG. 13(B) show diagrams showing an example of the FRC data in the fifth frame.

FIG. 14 shows an explanatory diagram of a processing example of MLS decode.

FIG. 15(A) and FIG. 15(B) show diagrams showing an example of the processing result of the MLS decode at the even-numbered terminal of the segment output in the fifth frame.

FIG. 16(A) and FIG. 16(B) show diagrams showing an example of the processing result of the MLS decode at the odd-numbered terminal of the segment output in the fifth frame.

FIG. 17 shows a block diagram of a configuration example of the liquid crystal driving device in the present embodiment.

FIG. 18 shows a diagram showing the outlines of the configuration of a setting register shown in FIG. 17.

FIG. 19 shows an explanatory diagram of a PWM setting register in FIG. 18.

FIG. 20 shows an explanatory diagram of a first gradation level setting register in FIG. 18.

FIG. 21 shows a diagram showing an example of a block diagram of main portions constituting the liquid crystal driving device in FIG. 17.

FIG. 22 shows a block diagram of a configuration example of a gradation processing circuit in FIG. 21.

FIG. 23 shows an explanatory diagram of the advantages of the present embodiment.

FIG. 24 shows a diagram showing an example of a block diagram of main portions constituting a liquid crystal driving device in a first modification of the present embodiment

FIG. 25 shows a diagram showing a block diagram of an example of the configuration of a gradation processing circuit in FIG. 24.

FIG. 26 shows a block diagram of an example of the configuration of an electronic instrument in a second modification.

### DETAILED DESCRIPTION OF EXEMPLARY EMBODIMENTS

An embodiment of the present invention will hereinafter be described in detail with reference to the drawings. It should be noted that the embodiment described below does not limit unreasonably the contents of the present invention described in claims. In addition, all of the configurations described below are not necessarily indispensable constituent features for solving the problems in the present invention.

### 1. Electronic Instrument

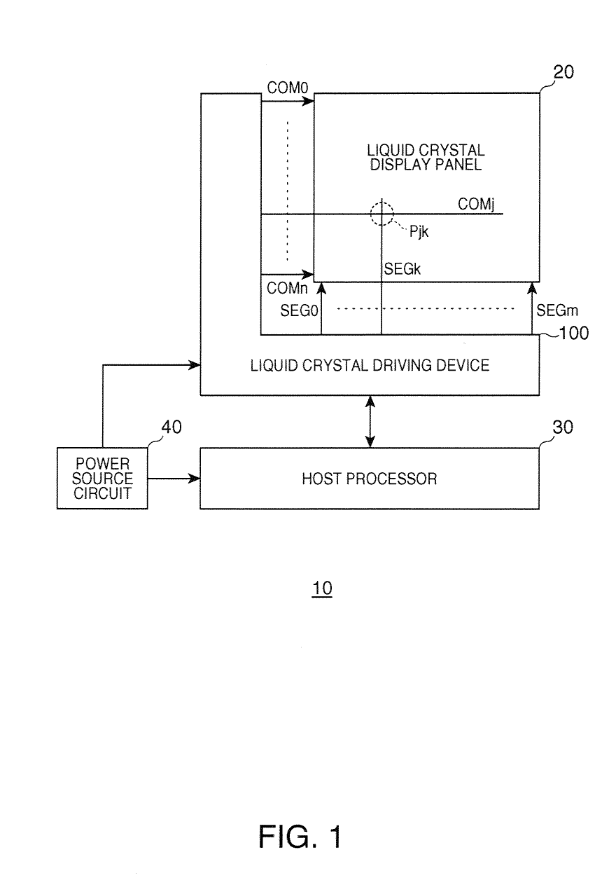

FIG. 1 shows a block diagram of a configuration example of an electronic instrument to which an electro optical device according to one embodiment of the present invention is applied.

An electronic instrument 10 includes a liquid crystal display panel (electro optical device in a broad sense) 20, a host processor 30, a power source circuit 40, and a liquid crystal driving device 100. The liquid crystal display panel 20 is a display panel of a simple matrix type. The liquid crystal display panel 20 is formed by sealing-in a plurality of common electrodes COM0 to COMn (n is a positive integer) and a plurality of segment electrodes SEG0 to SEGm (m is a positive integer) formed of a transparent electrode and placed to intersect each other, an orientation film, a liquid crystal and the like between a pair of transparent glass substrates. In the liquid crystal display panel 20, dots are formed in correspondence with the intersecting regions of the common electrodes and the segment electrodes. For example, a dot Pjk is formed in correspondence with the intersecting region of a common electrode COMj (0≦j≦n, j is an integer) and a segment electrode SEGk (0≦k≦m, k is an integer).

The liquid crystal driving device 100 is electrically connected to the common electrodes and the segment electrodes of the liquid crystal display panel 20. The liquid crystal driving device 100 is configured to allow the driving of the liquid crystal display panel 20 with the MLS driving method. Specifically, the liquid crystal driving device 100 simultaneously selects a plurality of common electrodes of the liquid crystal display panel 20 and performs driving on a plurality of occasions in a plurality of field periods provided by dividing a single frame period as a period necessary for displaying a single screen. The simultaneously selected plurality of common electrodes are driven in any of a plurality of sub-selection periods provided by dividing each of the field periods. The liquid crystal driving device 100 drives the simultaneously selected plurality of common electrodes based on a selection pattern (scanning pattern) for each of the sub-selection periods and applies a driving voltage in accordance with the result of given MLS computing based on the selection pattern and display data to a plurality of segment electrodes.

The host processor 30 reads a program stored in memory built into the processor or memory, not shown, and performs processing in accordance with the program, thereby performing the driving control of the liquid crystal driving device 100. Thus, the host processor 30 controls the operation of the liquid crystal driving device 100 by setting control data in a setting register built into the liquid crystal driving device 100. In addition, the host processor 30 supplies the liquid crystal driving device 100 with display data in association with images to be displayed on the liquid crystal display panel 20.

The power source circuit 40 supplies each of the host processor 30 and the liquid crystal driving device 100 with an operation power source voltage and a driving power source voltage for the liquid crystal display panel 20, or a reference voltage for producing these voltages.

Examples of the electronic instrument 10 having the configuration shown in FIG. 1 include a cellular phone, a personal computer, a Personal Digital Assistant (PDA), a digital still camera, a television, a video camera, a car navigation device, an electronic instrument for mounting on a car, a pager, an electronic notepad, an electronic paper, a calculator, a word processor, a workstation, a picturephone, a POS (Point of sale system) terminal, a printer, a scanner, a copier, a video player, an instrument equipped with a touch panel and the like.

### 2. Liquid Crystal Driving Method

The liquid crystal driving device 100 drives the liquid crystal display panel 20 with the MLS driving. The MLS driving can reduce the interval of the period in which the common electrode is selected as compared with a so-called line sequential driving method, and can suppress a reduction in transmittance of the liquid crystal display panel 20 and can improve the average transmittance. In addition, a plurality of common electrodes are simultaneously selected, so that a driving voltage (selection voltage) applied to the common electrodes can be reduced.

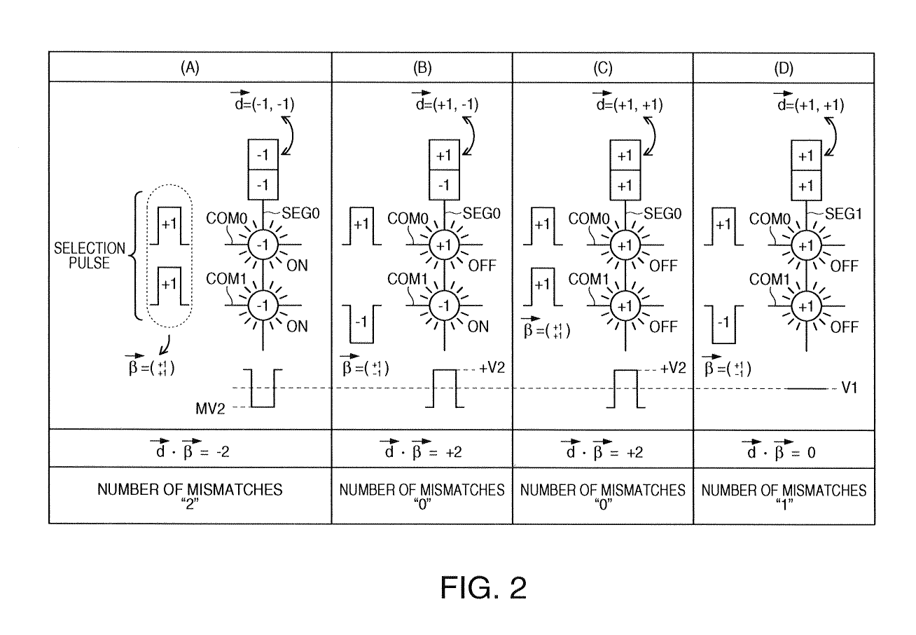

FIG. 2 shows an explanatory diagram of the principles of the MLS driving method. Each of FIG. 2(A) to FIG. 2(D) shows an example in which pixels (dots) at the positions where the common electrodes COM0, COM1 intersect the segment electrode SEG0 are turned on or turned off. It should be noted that FIG. 2 shows an example of the MLS driving method of two-line simultaneous selection in which the common electrodes COM0, COM1 on two lines are simultaneously selected.

In FIG. 2, a pixel to be turned on (on pixel) is represented as “−1,” a pixel to be turned off (off pixel) is represented as “+1,” and the pixels are specified by the display data which indicates the turn-on or the turn-off. The selection pattern for selecting each of the common electrodes COM0, COM1 is represented by two values of “+1” and “−1.” In addition, the driving voltage for the segment electrode SEG0 has three values of “MV2,” “V2,” and “V1.”

In the MLS driving method, the driving voltage for the segment electrode SEG0 is determined by the display data and the selection pattern of the simultaneously selected common electrodes COM0, COM1. Assuming that the display data is a display data vector d and the selection pattern is a matrix β, the product of the display data vector d and the matrix βdetermines whether the voltage of “MV2,” “V2,” or “V1” is used as the driving voltage for the segment electrode SEG0. The display data vector d is a vector representation of the data which indicates the turn-on or the turn-off of the pixel at the position where the segment electrode SEG0 intersects each of the common electrodes. In the case of FIG. 2(A), dβ=−2, in the case of FIG. 2(B), dβ=+2, in the case of FIG. 2(C), dβ=+2, and in the case of FIG. 2(D), dβ=0.

When the product of the display data vector d and the matrix β is “−2,” “MV2” is selected as the driving voltage for the segment electrode SEG0. When the product is “+2,” “V2” is selected. When the product is “0,” “V1” is selected.

For example, in performing the computing of the product of the display data vector d and the matrix β with hardware, the number of the mismatches between respective element data of the display data vector d and respective element data of the matrix β may be determined. For example, when the number of the mismatches is “2,” “MV2” is selected as the driving voltage for the segment electrode SEG0. When the number of the mismatches is “0”, “V2” is selected as the driving voltage. When the number of the mismatches is “1,” “V1” is selected as the driving voltage.

In the MLS driving method of the two-line simultaneous selection, the driving voltage for the segment electrode SEG0 is determined as described above and two field periods are provided within a single frame period to control the turn-on or the turn-off of the pixel. Since the plurality of field periods are provided, a reduction in transmittance in a non-field period is suppressed, the average transmittance of the liquid crystal panel is improved, and the contrast of the liquid crystal panel can be improved. In the present embodiment, the MLS driving method in which the common electrodes on four lines are simultaneously selected is performed. In this case, four field periods can be provided within a single frame period, and the contrast of the liquid crystal display panel 20 can be further improved. In the MLS driving method of the four-line simultaneous selection, seven levels of voltage are used.

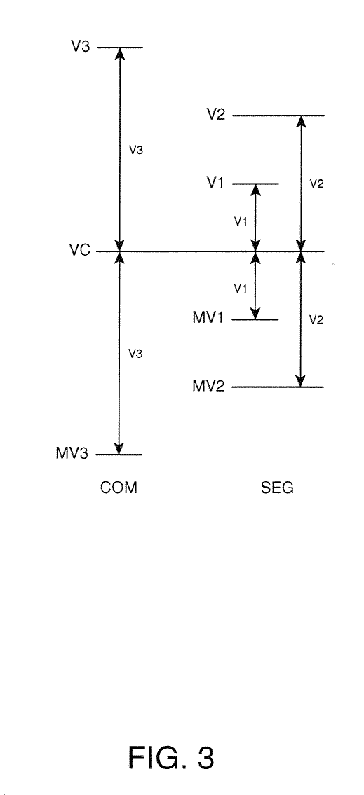

FIG. 3 shows the relationship of the seven levels of voltage when the liquid crystal display panel 20 is driven with the MLS driving method of the four-line simultaneous selection.

Voltages V3, MV3 are selection voltages for the common electrode. A voltage VC is a non-selection voltage for the common electrode and is a driving voltage for the segment electrode. Voltages V2, V1, MV1, and MV2 are driving voltages for the segment electrode. The transmittance of the pixel varies depending on a voltage difference between the intersecting common electrode and segment electrode.

Assume that the voltage difference between the voltage V3 and the center voltage VC is v₃, the voltage difference between the voltage V2 and the center voltage VC is v₂, and the voltage difference between the voltage V1 and the center voltage VC is v₁. In this case, the voltage difference between the center voltage VC and the voltage MV3 is v₃, the voltage difference between the center voltage VC and the voltage MV2 is v₂, and the voltage difference between the center voltage VC and the voltage MV1 is v₁. The voltage difference between the voltage V2 and the voltage V1 (=the voltage difference between the voltage MV1 and the voltage MV2) is equal to the voltage difference between the voltage V1 and the center voltage VC (=the voltage difference between the center voltage VC and the voltage MV1).

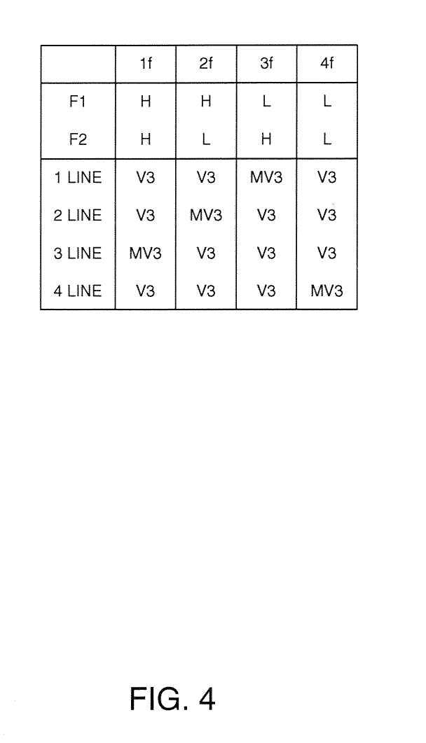

FIG. 4 shows an example of the selection pattern when the MLS driving method of the four-line simultaneous selection is performed. It should be noted that while FIG. 4 represents the example of the selection pattern when a liquid crystal alternating signal FR, later described, is at an L level, the selection pattern in association with a voltage applied to each of the common electrodes is also provided for each of the field periods when the liquid crystal alternating signal is at an H level.

Each of the field periods provided within a single frame period in the MLS driving method is specified by field signals F1, F2 in the liquid crystal driving device 100. The liquid crystal driving device 100 outputs the voltage V3 or the voltage MV3 to each of the common electrodes for each of the field periods corresponding to four states represented by the field signals F1, F2 of two bits shown in FIG. 4. The pattern of the outputs to the respective common electrodes in each of the field periods shown in FIG. 4 is defined as the selection pattern (scanning pattern) by an orthogonal functional system. The liquid crystal driving device 100 appropriately selects one of the three types of the driving voltages V3, VC, and MV3 in accordance with the selection pattern defined by the previously determined orthogonal functional system and applies the selected voltage to each of the simultaneously selected common electrodes.

Each of the field periods is divided into a plurality of sub-selection periods assigned for each of the pluralities of the simultaneously selected common electrodes. Out of the plurality of sub-selection periods provided by dividing a first field period (1f), in a sub-selection period in which the simultaneously selected common electrodes COM0 to COM3 are selected, the following operation is performed. The liquid crystal driving device 100 selects one of the voltages (V2, V1, VC, MV1, MV2) for output to the segment electrode SEG0 in accordance with the number of the mismatches of polarities between the display pattern of each dot corresponding to the intersecting position of the segment electrode SEG0 and each of the simultaneously selected common electrodes COM0 to COM3 and the selection pattern, and applies the selected voltage to the segment electrode SEG0. Similarly, the device 100 applies the selected voltage to the other segment electrodes.

Next, out of the plurality of sub-selection periods provided by dividing the first field period, in a sub-selection period in which the simultaneously selected common electrodes COM4 to COM7 are selected, the number of mismatches in the column of each of the segment electrodes is determined and the obtained voltage data is applied. After the procedure described above is repeated for all of the common electrodes in this manner, the operation in the first field period is finished.

Similarly, after the procedure described above is repeated for every common electrodes in the second and subsequent periods, a single frame period finished and, as a result, a single screen is displayed.

### 3. Gradation Display Method

The liquid crystal driving device 100 performs the gradation display with the PWM scheme and the FRC scheme in each of the selection periods in performing the liquid crystal driving with the MLS driving method described above. In the PWM scheme, each of the sub-selection periods is divided into a plurality of divided periods, and the driving voltage is adjusted in each of the divided periods to realize the gradation display with the PWM. In the FRC scheme, the turn-on and the turn-off of dots are switched over a plurality of frames to realize the gradation display with the FRC. In this case, the display data is processed as described below to enable an increase in the degree of flexibility in the combination of the settings of the PWM scheme and the settings of the FRC scheme to increase the degree of flexibility in the concentration settings for halftones.

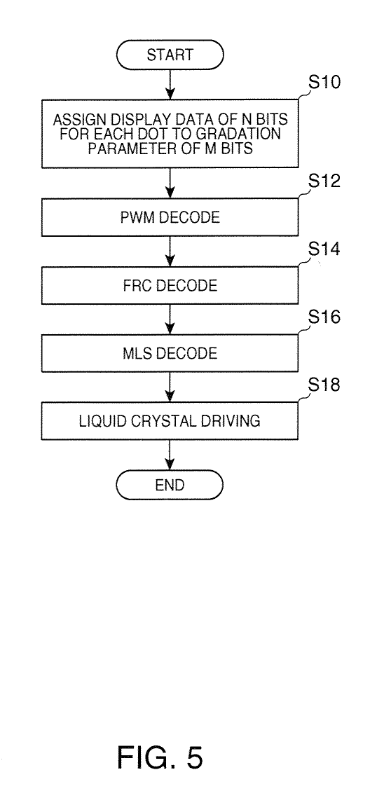

FIG. 5 shows an example of a flow of a gradation display method in the liquid crystal driving device 100.

First, the liquid crystal driving device 100 assigns display data of N bits (N is an integer equal to or larger than two) per dot to a gradation parameter of M bits (N<M, M is an integer) as a gradation parameter assigning step (step S10). Next, the liquid crystal driving device 100 performs PWM decoding on the gradation parameter assigned at step S10 as a PWM decode step (step S12) and determines one of a plurality of divided periods provided by dividing each of the sub-selection periods. Then, the liquid crystal driving device 100 performs FRC decode on the gradation parameter as an FRC decode step (step S14) and determines the turn-on or the turn-off of the dot in that frame in the series of frames. In addition, the liquid crystal driving device 100 performs MLS decode on the display pattern (the signal indicating the turn-on or the turn-off) indicated by the FRC pattern which is the result of the FRC decode performed at step S14 as an MLS decode step (step S16) and determines the driving voltage for each of the segment electrodes in accordance with the selection pattern of the simultaneously selected common electrodes as described above. Finally, the liquid crystal driving device 100 drives the liquid crystal display panel 20 based on the result of the MLS decode at step S16 (step S18) and applies the voltage in accordance with the selection pattern of the simultaneously selected common electrodes to the common electrodes and applies the driving voltage determined at step S16 to each of the segment electrodes.

Here, when the sub-selection period is divided into a first divided period and a second divided period, the first divided or the second divided period is selected on the basis of part of the gradation parameter assigned at step S10. The driving step at step S18 can include a first divided period driving step and a second divided period driving step. At the first divided period driving step, in the first divided period in association with part of the gradation parameter assigned at step S10, the driving voltage in accordance with the result of the MLS computing on the display pattern indicated by the first FRC pattern selected on the basis of part of the gradation parameter is applied to the plurality of segment electrodes. At the second divided period driving step, in the second divided period in association with part of the gradation parameter assigned at step S10, the driving voltage in accordance with the result of the MLS computing on the display pattern indicated by the second FRC pattern selected on the basis of part of the gradation parameter is applied to the plurality of segment electrodes.

Specifically, at step S10, a bit string of at least part of the gradation parameter can be used for a parameter for control of the PWM, and a bit string of at least other part of the gradation parameter can be used for a parameter for control of the FRC. As a result, at step S12, selection can be made as appropriate from the plurality of divided periods and the selected divided period is used to allow the PWM, regardless of the original display data. Thus, in combination with the FRC scheme, finer gradation representations can be performed in the driving step at step S18.

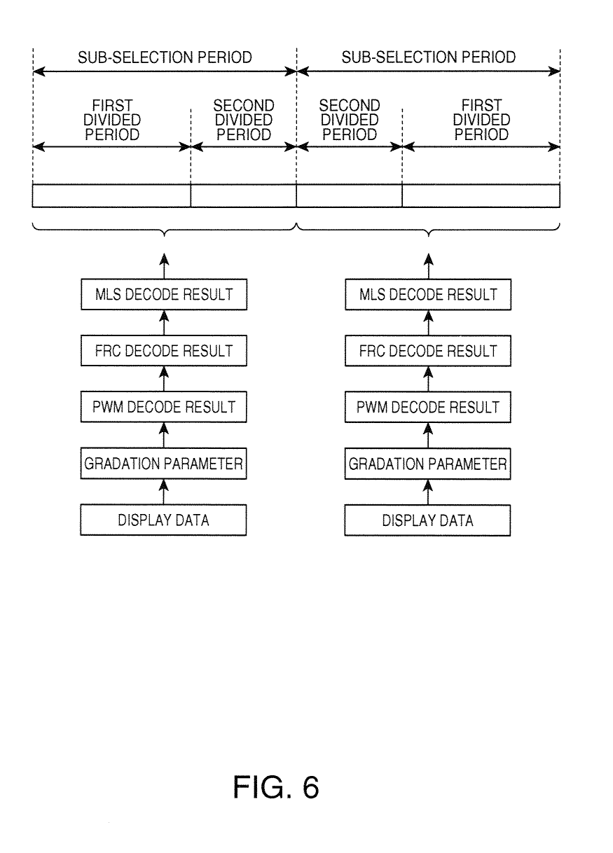

FIG. 6 shows an explanatory diagram of a liquid crystal driving method with the liquid crystal driving device 100 in the present embodiment. FIG. 6 schematically shows the driving operation in the same segment electrode.

In the present embodiment, with the MLS driving method, the driving is performed on a plurality of occasions by using the plurality of field periods constituting the single frame period. Each of the field periods has a plurality of sub-selection periods divided for each of the groups of the simultaneously selected common electrodes. In each of the sub-selection periods, the driving voltage in accordance with the selection pattern of the simultaneously selected common electrodes is applied to the plurality of segment electrodes. In other words, the selection periods of the simultaneously selected common electrodes are separated in the sub-selection periods within each of the field periods. At this point, each of the sub-selection periods is divided into a plurality of divided periods with the PWM, and the driving voltage in accordance with the result of the MLS decode based on the result of the PWM decode and the result of the FRC decode is applied to each of the segment electrodes in each of the divided periods.

In the following, it is assumed that each of the sub-selection periods is divided into two with the PWM and is divided into the first divided period (for example, a narrow-width period) and the second divided period (for example, a wide-width period). However, the present embodiment is not limited by the number of the divided sub-selection periods.

In the present embodiment, as shown in FIG. 6, when the second divided period is started after the first divided period in the sub-selection period in association with the common electrode COM0 to COM3, randomization in which the first divided period is started after the second divided period is performed in the next sub-selection period in association with the common electrodes COM0 to COM3. This can prevent the deterioration of the display quality of the gradation display of halftones.

In the following, the principles of the gradation display method in the present embodiment will be described. To facilitate the description, it is assumed that the gradation display of four gradations (a gradation level (0, 0), a gradation level (0, 1), a gradation level (1, 0), and a gradation level (1, 1)) is performed for the display data of two bits per dot.

In the PWM in the present embodiment, the sub-selection period defined by using 16 internal pulses is divided into the two, that is, the narrow-width period having a narrow width and the wide-width period having a wide width, and the concentration setting of each of the gradation levels of the halftones (0, 1), (1, 0) can be assigned to the narrow-width period or the wide-width period. In addition, in the present embodiment, the concentration setting of the gradation level of the halftone can be assigned to an arbitrary gradation level in the FRC. In the following, it is assumed that the concentration setting of the gradation level of the halftone (0, 1) is assigned to the gradation level ¼ in the FRC, and the concentration setting of the gradation level of the halftone (1, 0) is assigned to the gradation level ⅓ in the FRC.

In this manner, the gradation level of the halftone is assigned to an arbitrary divided period in the PWM (the wide-width period, the narrow-width period) or is assigned to an arbitrary gradation level in the FRC, thereby making it possible to increase the degree of flexibility in the combinations of the settings of the PWM scheme and the settings of the FRC scheme to increase the degree of flexibility in the concentration settings for the halftones. Thus, the display data of the N bits per dot is assigned to the gradation parameter of the M bits, so that the gradation parameter after the assignment can be used to specify the divided period in the PWM and the gradation level in the FRC.

First, description will be made of the gradation display method based on the following display data of four gradations.

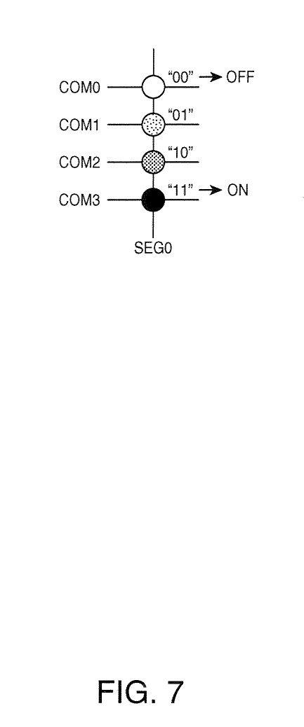

FIG. 7 shows an example of the display data in the present embodiment.

In FIG. 7, the dots provided in the intersecting regions of the simultaneously selected common electrodes COM0 to COM3 and, for example, the segment SEG0, are represented with display data D0 to D7. It is assumed that display data (D1, D0) is (0, 0) and indicates that the dot provided in the intersecting region of the common electrode COM0 and the segment electrode SEG0 is off (0%). It is assumed that display data (D3, D2) is (0, 1) and indicates that the dot provided in the intersecting region of the common electrode COM1 and the segment electrode SEG0 is of a light halftone. It is assumed that display data (D5, D4) is (1, 0) and indicates that the dot provided in the intersecting region of the common electrode COM2 and the segment electrode SEG0 is of a dark halftone. It is assumed that display data (D7, D6) is (1, 1) and indicates that the dot provided in the intersecting region of the common electrode COM3 and the segment electrode SEG0 is on (100%).

In the following, description will be made on the assumption that the data displayed by the dots provided in the intersecting regions of the simultaneously selected common electrodes COM0 to COM3 and, for example, the segment electrode SEG1, is similar to that shown in FIG. 7 as appropriate. The display data in FIG. 7 is converted into PWM data as described below through the PWM decode.

### 3.1 PWM Decode

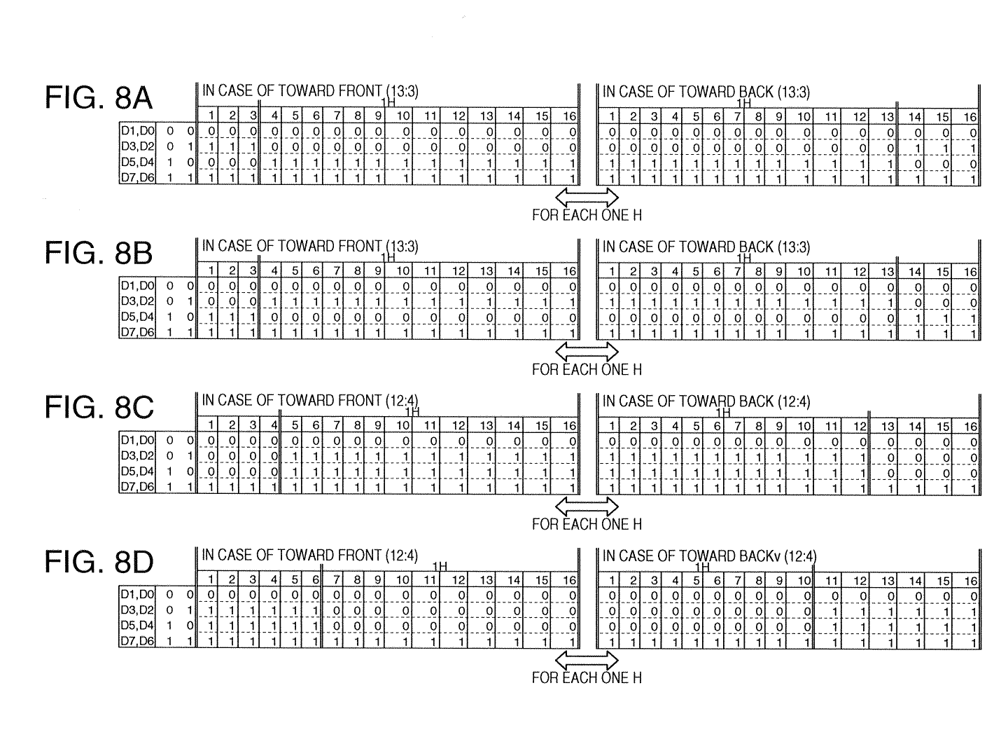

FIG. 8(A), FIG. 8(B), FIG. 8(C), and FIG. 8(D) show explanatory diagrams of PWM data in association with the display data. FIG. 8(A) represents the example in which the concentration setting of the gradation level (0, 1) is assigned to the period corresponding to three pulses (narrow-width period= 3/16) and the concentration setting of the gradation level (1, 0) is assigned to the period corresponding to 13 pulses (wide-width period= 13/16). FIG. 8(B) represents the example in which the concentration setting of the gradation level (0, 1) is assigned to the period corresponding to 13 pulses (width-width period= 13/16) and the concentration setting of the gradation level (1, 0) is assigned to the period corresponding to three pulses (narrow-width period= 3/16). FIG. 8(C) represents the example in which the concentration setting of the gradation level (0, 1) is assigned to the period corresponding to 12 pulses (width-width period= 12/16) and the concentration setting of the gradation level (1, 0) is assigned to the period corresponding to 12 pulses (wide-width period= 12/16). FIG. 8(D) represents the example in which the concentration setting of the gradation level (0, 1) is assigned to the period corresponding to six pulses (narrow-width period= 6/16) and the concentration setting of the gradation level (1, 0) is assigned to the period corresponding to six pulses (narrow-width period= 6/16).

In the setting example of FIG. 8(A), when the display data is (0, 0), the PWM data remains “0” regardless of the divided period. Similarly, when the display data is (1, 1), the PWM data remains “1” regardless of the divided period. In contrast, when the display data is (0, 1), the assigned narrow-width period represents “1” and the wide-width period represents “0.” Similarly, when the display data is (1, 0), the assigned wide-width period represents “1” and the narrow-width period represents “0.” The narrow-width period and the wide-width period are switched back and forth for each one horizontal scanning period (predetermined period in a broad sense).

Similarly, in the setting example of FIG. 8(B), when the display data is (0, 0), the PWM data remains “0” regardless of the divided period. Similarly, when the display data is (1, 1), the PWM data remains “1” regardless of the divided period. In contrast, when the display data is (0, 1), the assigned wide-width period represents “1” and the narrow-width period represents “0.” Similarly, when the display data is (1, 0), the assigned narrow-width period represents “1” and the wide-width period represents “0.” The narrow-width period and the wide-width period are switched back and forth for each one horizontal scanning period.

In the setting examples of FIG. 8(C) and FIG. 8(D), when the display data is (0, 0), the PWM data remains “0” regardless of the divided period. When the display data is (1, 1), the PWM data remains “1” regardless of the divided period. In contrast, in FIG. 8(C), when the display data is (0, 1), the assigned wide-width period represents “1” and the narrow-width period represents “0.” Similarly, when the display data is (1, 0), the assigned wide-width period represents “1” and the narrow-width period represents “0.” In FIG. 8(D), when the display data is (0, 1), the assigned narrow-width period represents “1” and the wide-width period represents “0.” Similarly, when the display data is (1, 0), the assigned narrow-width period represents “1” and the wide-width period represents “0.” In FIG. 8(C), FIG. 8(D), the narrow-width period and the wide-width period are also switched back and forth for each one horizontal scanning period.

In FIG. 8(A) to FIG. 8(D), the timing of the switching between the narrow-width period and the wide-width period can be provided not only for each one horizontal scanning period but also for each of pluralities of horizontal scanning periods, for each of frame periods or of pluralities of frame periods, or for each of sub-selection periods or of pluralities of sub-selection periods.

Subsequently, the PWM data is created such that the narrow-width period and the wide-width period are switched back and forth for each of predetermined periods (for example, a single or a plurality of frame periods) in the segment output and that the narrow-width period and the wide-width period are placed in the front and the back in alternate order at even-numbered terminals (for example, the segment electrode SEG0) and odd-numbered terminals (for example, the segment electrode SEG1) of the segment output. In other words, the setting is performed such that the order of the narrow-width period and the wide-width period in the sub-selection period is reversed for each of segment outputs.

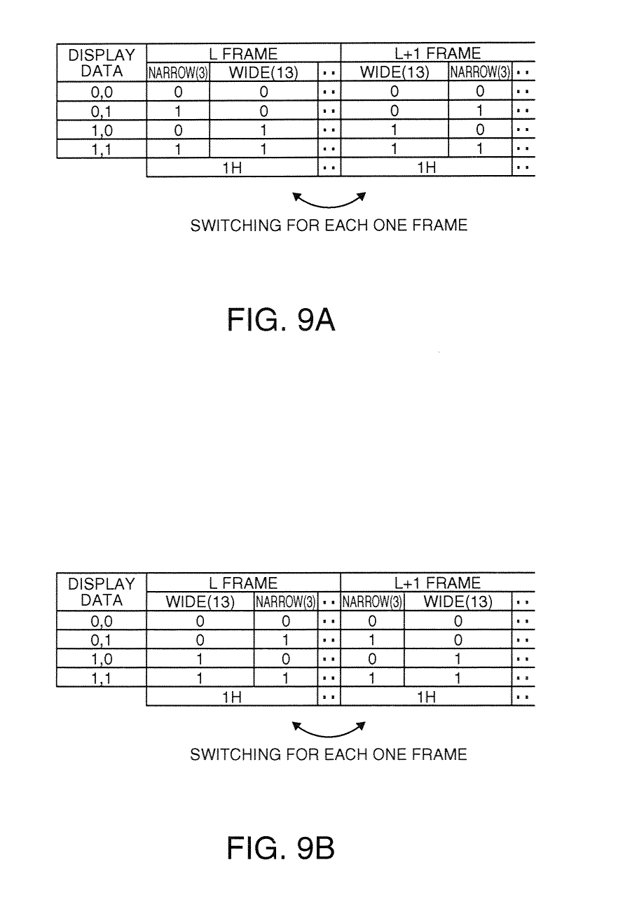

FIG. 9(A), FIG. 9(B) show explanatory diagrams of the PWM data at the even-numbered terminal and the odd-numbered terminal of the segment output. FIG. 9(A) shows the outlines of the PWM data at the even-numbered terminals of the segment output. FIG. 9(B) shows the outlines of the PWM data at the odd-numbered terminals of the segment output.

As shown in FIG. 9(A), at the even-numbered terminal of the segment output, the PWM data is created such that the narrow-width period and the wide-width period are switched back and forth for each one frame period. In addition, the randomization is performed such that the odd-numbered terminal of the segment output is in the wide-width period when the even-numbered terminal of the segment output is in the narrow-width period and that the odd-numbered terminal of the segment output is in the narrow-width period when the even-numbered terminal of the segment output is in the wide-width period.

Similarly, as shown in FIG. 9(B), at the odd-numbered terminal of the segment output, the PWM data is created such that the narrow-width period and the wide-width period are switched back and forth for each one frame period. In addition, the randomization is performed such that the even-numbered terminal of the segment output is in the wide-width period when the odd-numbered terminal of the segment output is in the narrow-width period and that the even-numbered terminal of the segment output is in the narrow-width period when the odd-numbered terminal of the segment output is in the wide-width period.

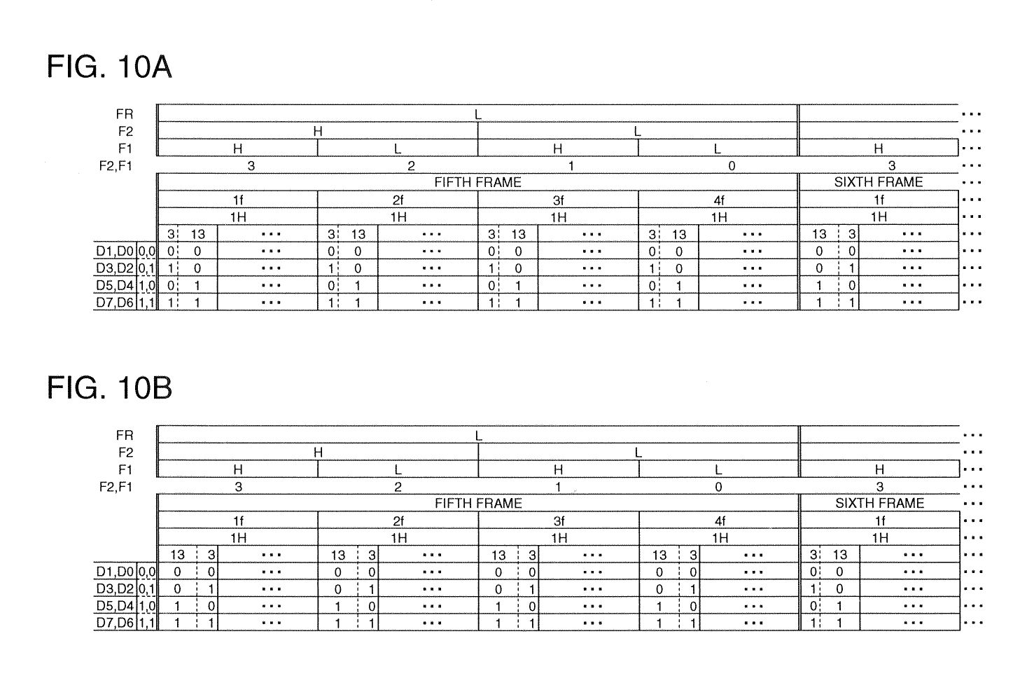

FIG. 10(A), FIG. 10(B) show an example of the PWM data in the fifth frame. FIG. 10(A), FIG. 10(B) represent the example in which the concentration setting of the gradation level (0, 1) is assigned to the period corresponding to three pulses (narrow-width period= 3/16) and the concentration setting of the gradation level (1, 0) is assigned to the period corresponding to 13 pulses (wide-width period= 13/16). FIG. 10(A) represents the example of the PWM data at the even-numbered terminal of the segment output, and FIG. 10(B) represents the example of the PWM data at the odd-numbered terminal of the segment output.

As shown from FIG. 8(A), FIG. 9(A), and FIG. 9(B) to FIG. 10(A), FIG. 10(B), the liquid crystal alternating signal FR which switches the polarity of the voltage applied to the liquid crystal, the field signals F1, F2, the display data, and the PWM data in the divided period in each of the fields are shown.

### 3.2 FRC Decode

After the PWM decode is performed on the display data as described above and the divided period is selected, the FRC decode is performed. The FRC decode is processing of producing a signal which specifies turn-on or turn-off for each of the frames with the display pattern indicated by the FRC pattern in association with the PWM data produced on the basis of the display data.

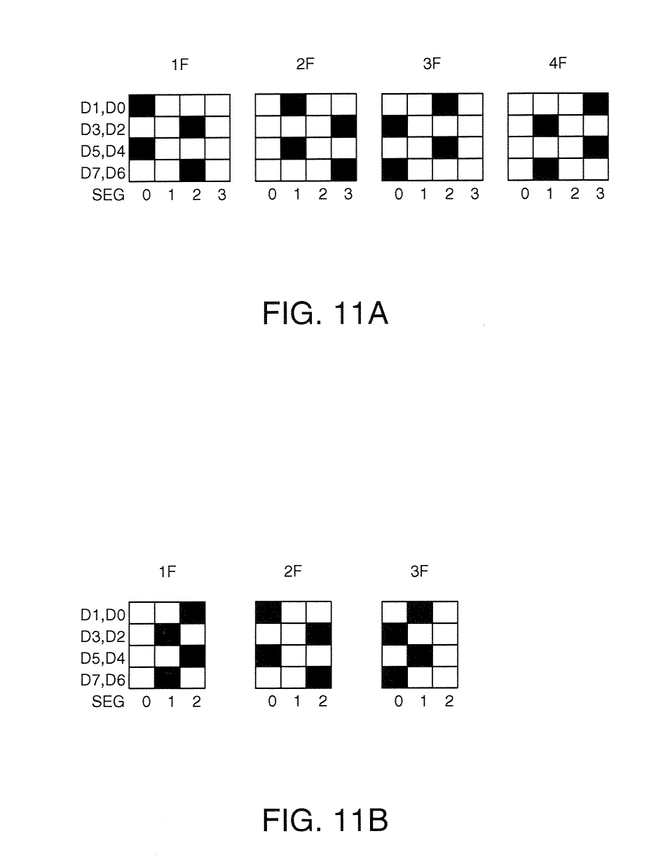

FIG. 11(A), FIG. 11(B) show an example of the FRC pattern in the present embodiment. FIG. 11(A) represents the example of the FRC pattern at the gradation level ¼ of the FRC. FIG. 11(B) represents the example of the FRC pattern at the gradation level ⅓ of the FRC. In the FRC pattern of FIG. 11(A), for each of the frames from the first frame (1F) to the fourth frame (4F), four dots in a vertical direction correspond to the simultaneously selected four lines, a horizontal direction corresponds to the segment electrode SEG0 to SEG3, and the similar display pattern is repeated for each of groups of four outputs in the horizontal direction. In the FRC pattern of FIG. 11(B), for each of the frames from the first frame (1F) to the third frame (3F), four dots in a vertical direction correspond to the simultaneously selected four lines, a horizontal direction corresponds to the segment electrode SEG0 to SEG2, and the similar display pattern is repeated for each of groups of three outputs in the horizontal direction. While each of FIG. 11(A), FIG. 11(B) shows only part of the FRC pattern, the FRC pattern having a different pattern indicating turn-on or turn-off is also provided for the other gradation levels.

The gradation level (0, 1) corresponds to the gradation level ¼ of the FRC, and the gradation level (1, 0) corresponds to the gradation level ⅓. Thus, when the display (D1, D0) is (0, 0), “0” is output in all of the frames regardless of the FRC. When the display data (D7, D6) is (1, 1), “1” is output in all of the frames regardless of the FRC. In contrast, since the display data (D3, D2) is (0, 1), a signal which specifies turn-on or turn-off of each of the frames for each of the segment outputs is produced in accordance with the FRC pattern of FIG. 11(A). Similarly, since the display data (D5, D4) is (1, 0), FRC data which specifies turn-on or turn-off of each of the frames for each of the segment outputs is produced in accordance with the FRC pattern of FIG. 11(B).

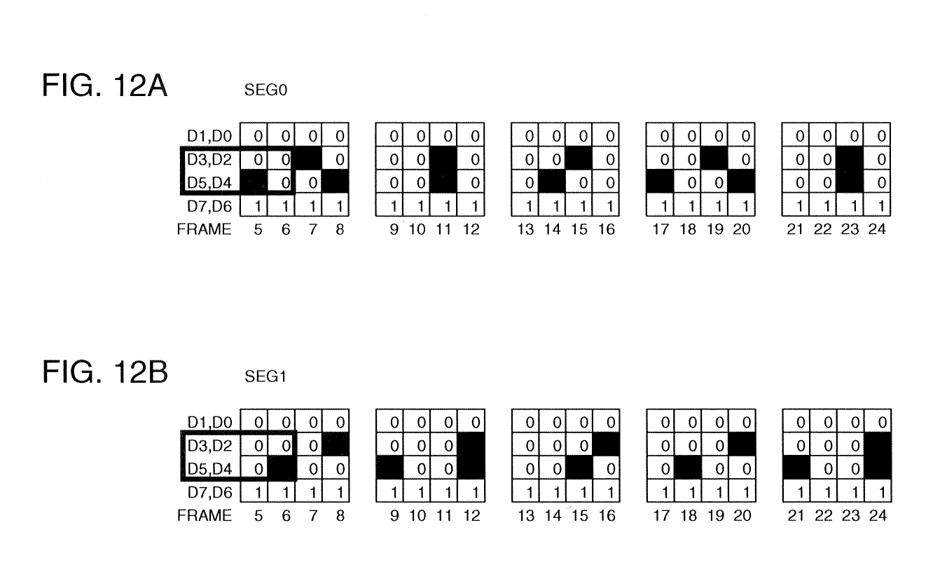

FIG. 12(A), FIG. 12(B) show an example of the FRC data in association with the FRC pattern selected on the basis of the display data. FIG. 12(A) represents the example of the FRC data for the segment electrode SEG0. FIG. 12(B) represents the example of the FRC data for the segment electrode SEG1. In FIG. 12(A) and FIG. 12(B), four dots in a vertical direction correspond to the simultaneously selected four lines, and a horizontal direction corresponds to the frames from the fifth frame. “0” indicates that the FRC data is “0,” “1” indicates that the FRC data is “1,” and the portion filled in with black represents the example in which the PWM data is output as it is as the FRC data.

As shown in FIG. 12(A), FIG. 12(B), since the display data (D1, D0) is (0, 0), “0” is output in all of the frames in the segment electrodes SEG0, SEG1, regardless of the FRC. Similarly, since the display data (D7, D6) is (1, 1), “1” is output in all of the frames in the segment electrodes SEG0, SEG1, regardless of the FRC.

On the other hand, for the segment electrode SEG0, since the display data (D3, 32) is (0, 1), the FRC data is produced in which the fifth frame represents “0,” the sixth frame represents “0,” the seventh frame represents the PWM data, the eighth frame represents “0,”, in accordance with the display pattern shown by the FRC pattern of FIG. 11(A). In addition, since the display data (D5, D4) is (1, 0), the FRC data is produced in which the fifth frame represents the PWM data, the sixth frame represents “0,” the seventh frame represents “0,” the eighth frame represents the PWM data, . . . , in accordance with the display pattern shown by the FRC pattern of FIG. 11(B).

For the segment electrode SEG1, since the display data (D3, D2) is (0, 1), the FRC data is produced in which the fifth frame to the seventh frames represent “0,” the eighth frame represents the PWM data, . . . , in accordance with the display pattern shown by the FRC pattern of FIG. 11(A). In addition, since the display data (D5, D4) is (1, 0), the FRC data is produced in which the fifth frame represents “0,” the sixth frame indicates the PWM data, the seventh frame and the eighth frame represent “0,”, in accordance with the display pattern shown by the FRC pattern of FIG. 11(B).

In the following, the similar FRC data is produced for the other segment electrodes.

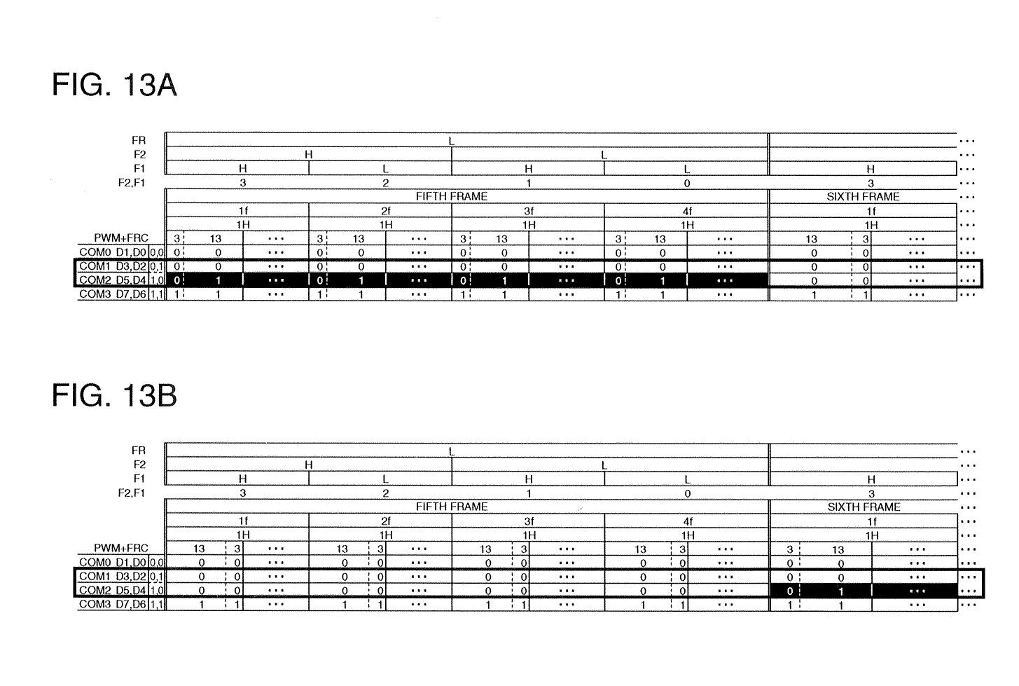

FIG. 13(A), FIG. 13(B) show an example of the FRC data in the fifth frame. FIG. 13(A), FIG. 13(B) represent the example in which the concentration setting of the gradation level (0, 1) is assigned to the period corresponding to three pulses (narrow-width period= 3/16) and the concentration setting of the gradation level (1, 0) is assigned to the period corresponding to 13 pulses (wide-width period= 13/16). FIG. 13(A) represents the example of the FRC data at the even-numbered terminal of the segment output, and FIG. 13(B) represents the example of the FRC data at the odd-numbered terminal of the segment output.

As shown from FIG. 10(A), FIG. 10(B), FIG. 12(A), and FIG. 12(B) to FIG. 13(A), FIG. 13(B), the liquid crystal alternating signal FR which switches the polarity of the voltage applied to the liquid crystal, the field signals F1, F2, the display data, and the FRC data in the divided period in each of the fields are shown.

FIG. 13(A) is produced on the basis of the FRC data in FIG. 12(A), and the FRC data in association with the common electrode COM0 is “0” in all of the frames. Similarly, the FRC data in association with the common electrode COM3 is “1” in all of the frames. On the other hand, the FRC data in association with the common electrode COM1 is “0” regardless of the PWM data as shown in FIG. 12(A). For the FRC data in association with the common electrode COM2, the PWM data is output as it is as shown in FIG. 12(A).

FIG. 13(B) is produced on the basis of the FRC data in FIG. 12(B), and the FRC data in association with the common electrode COM0 is “0” in all of the frames. Similarly, the FRC data in association with the common electrode COM3 is “1” in all of the frames. On the other hand, the FRC data in association with the common electrodes COM1, COM2 is “0” regardless of the PWM data as shown in FIG. 12(B). In the sixth frame, as shown in FIG. 12(B), for the FRC data in association with the common electrode COM2, the PWM data is output as it is.

### 3.3 MLS Decode

The FRC data described above is converted into the signal which selects the associated driving signal through the MLS decode in accordance with the result of the given MLS computing.

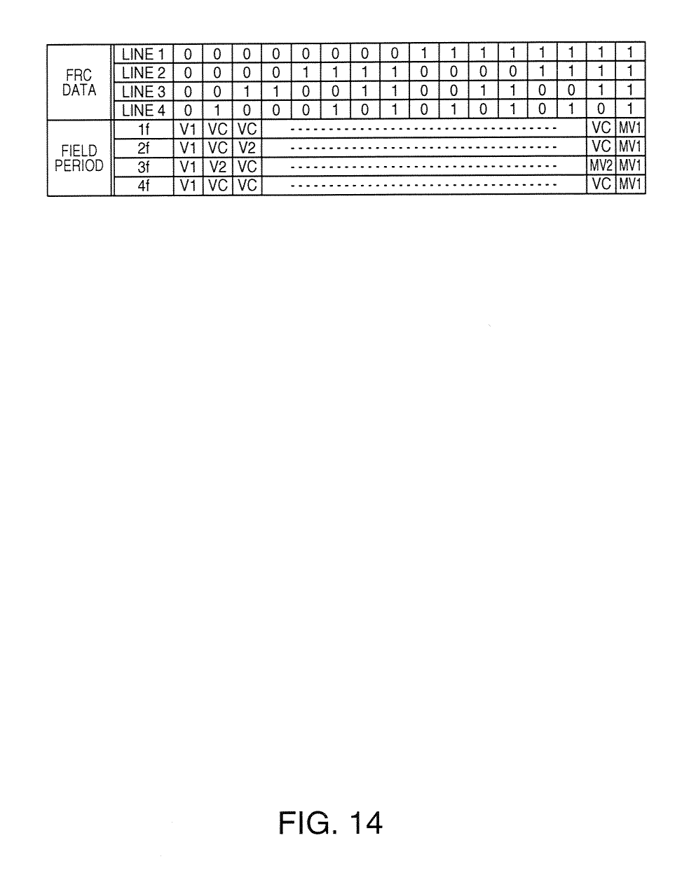

FIG. 14 shows an explanatory diagram of a processing example of the MLS decode. FIG. 14 represents the driving voltage applied to the segment electrode in each of the field periods in association with the FRC data for the four lines. FIG. 14 represents the driving voltage for each of the segment electrodes when the liquid crystal alternating signal FR is at the L level. When the liquid crystal alternating signal FR is at the H level, the driving voltage is produced such that the voltage applied to the liquid crystal has the reverse polarity in accordance with the selection pattern of the common electrodes.

In the MLS decode, the driving voltage for the segment electrode in each of the field periods is determined by the FRC data for the simultaneously selected four lines and the field signals F1 and F2. For example, when the FRC data for a line 1 in association with the display data of (D1, D0) is “0,” the FRC data for a line 2 in association with the display data of (D3, D2) is “0,” the FRC data for a line 3 in association with the display data of (D5, D4) is “1,” and the FRC data for a line 4 in association with the display data of (D7, D6) is “0,” then the driving voltage VC is selected in the first field period, the third field period, and the fourth field period, and the driving voltage V2 is selected in the second field period. The driving voltage is similarly selected for the other FRC data.

The processing contents of the MLS decode are not limited to those shown in FIG. 14, and modified processing contents for achieving higher quality of the gradation display can be applied.

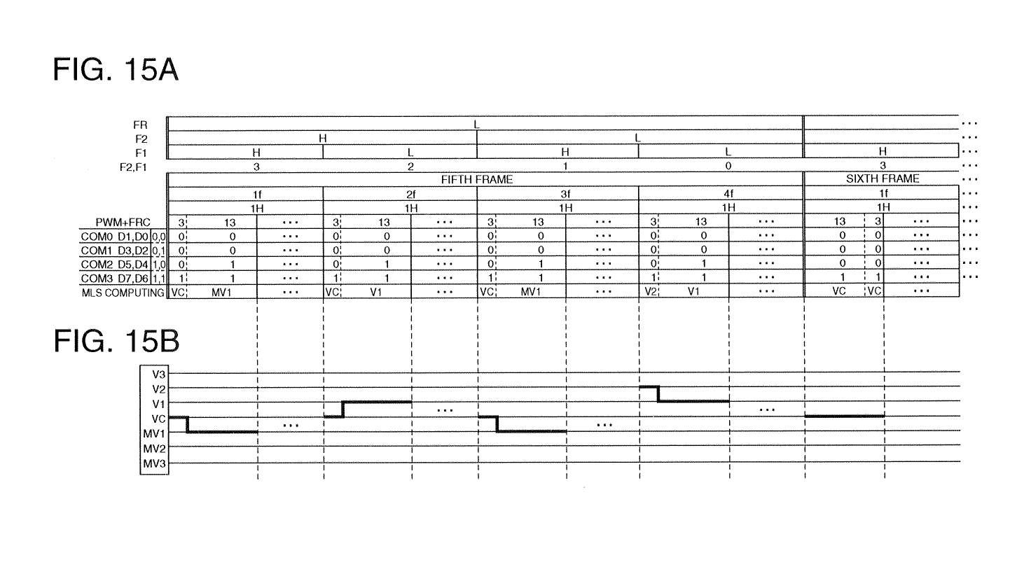

FIG. 15(A) and FIG. 15(B) show an example of the processing result of the MLS decode at the even-numbered terminal of the segment output in the fifth frame. FIG. 15(A) shows the example of the result of the MLS decode on the FRC data in each of the field periods. FIG. 15(B) schematically shows the example of the driving waveform in accordance with the result of the MLS decode in FIG. 15(A).

In the example shown in FIG. 15(A), after the driving voltage VC is output in the narrow-width period of the sub-selection period in which the common electrodes COM0 to COM3 are simultaneously selected within the first field period, the driving voltage MV1 is output in the wide-width period of that sub-selection period. Similarly, after the driving voltage VC is output in the narrow-width period of the sub-selection period in which the common electrodes COM0 to COM3 are simultaneously selected within the second field period, the driving voltage V1 is output in the wide-width period of that sub-selection period. The same applies to the other fields.

As a result, the driving voltage of the waveform shown in FIG. 15(B) is output to the even-numbered terminal of the segment output (for example, the segment electrode SEG0) in the narrow-width period and the wide-width period of the sub-selection period in which the common electrodes COM0 to COM3 are simultaneously selected within each of the field periods. Similarly, the driving voltage in accordance with the result of the MLS decode is output to the even-numbered terminal of the segment output in the narrow-width period and the wide-width period of the sub-selection period in which the common electrodes COM4 to COM7 are simultaneously selected within each of the field periods.

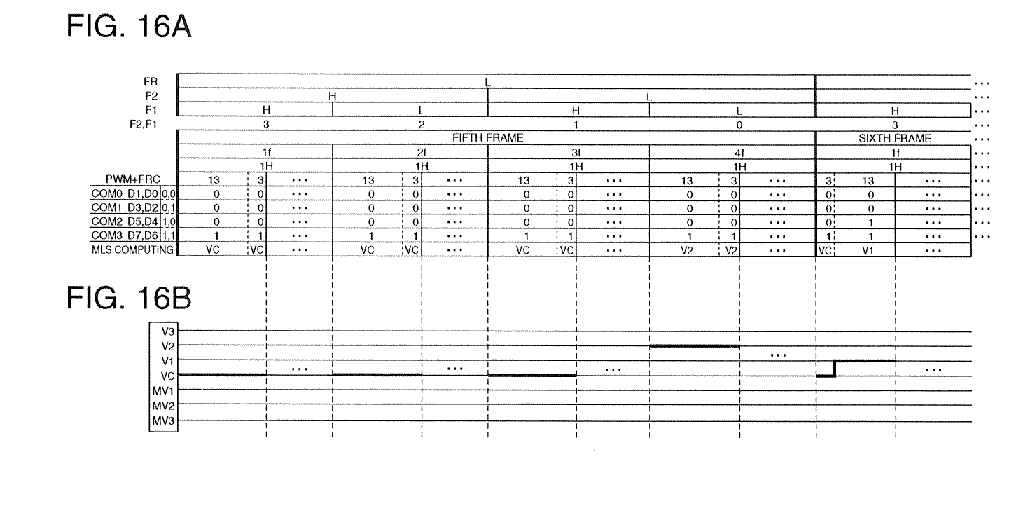

FIG. 16(A) and FIG. 16(B) show an example of the processing result of the MLS decode at the odd-numbered terminal of the segment output in the fifth frame. FIG. 16(A) shows the example of the result of the MLS decode on the FRC data in each of the field periods. FIG. 16(B) schematically shows the example of the driving waveform in accordance with the result of the MLS decode in FIG. 16(A).

In the example shown in FIG. 16(A), after the driving voltage VC is output in the wide-width period of the sub-selection period in which the common electrodes COM0 to COM3 are simultaneously selected within the first field period, the driving voltage VC is output in the wide-width period of that sub-selection period. Similarly, after the driving voltage VC is output in the wide-width period of the sub-selection period in which the common electrodes COM0 to COM3 are simultaneously selected within the second field period, the driving voltage VC is output in the narrow-width period of that sub-selection period. The same applies to the other fields.

As a result, the driving voltage of the waveform shown in FIG. 16(B) is output to the odd-numbered terminal of the segment output (for example, the segment electrode SEG1) in the wide-width period and the narrow-width period of the sub-selection period in which the common electrodes COM0 to COM3 are simultaneously selected within each of the field periods. Similarly, the driving voltage in accordance with the result of the MLS decode is output to the odd-numbered terminal of the segment output in the wide-width period and the narrow-width period of the sub-selection period in which the common electrodes COM4 to COM7 are simultaneously selected within each of the field periods.

In this manner, according to the present embodiment, the gradation display in the PWM scheme and the FRC scheme is performed in each of the selection periods in the liquid crystal driving with the MLS driving method. The gradation level of the halftone is assigned to an arbitrary divided period (wide-width period, narrow-width period) in the PWM or is assigned to an arbitrary gradation level in the FRC, thereby making it possible to increase the degree of flexibility in the combinations of the settings of the PWM scheme and the settings of the FRC scheme to increase the degree of flexibility in the concentration settings for the halftones.

### 4. Liquid Crystal Driving Device

Next, description will be made of a configuration example of the liquid crystal driving device 100 for performing the liquid crystal driving with the abovementioned MLS driving method.

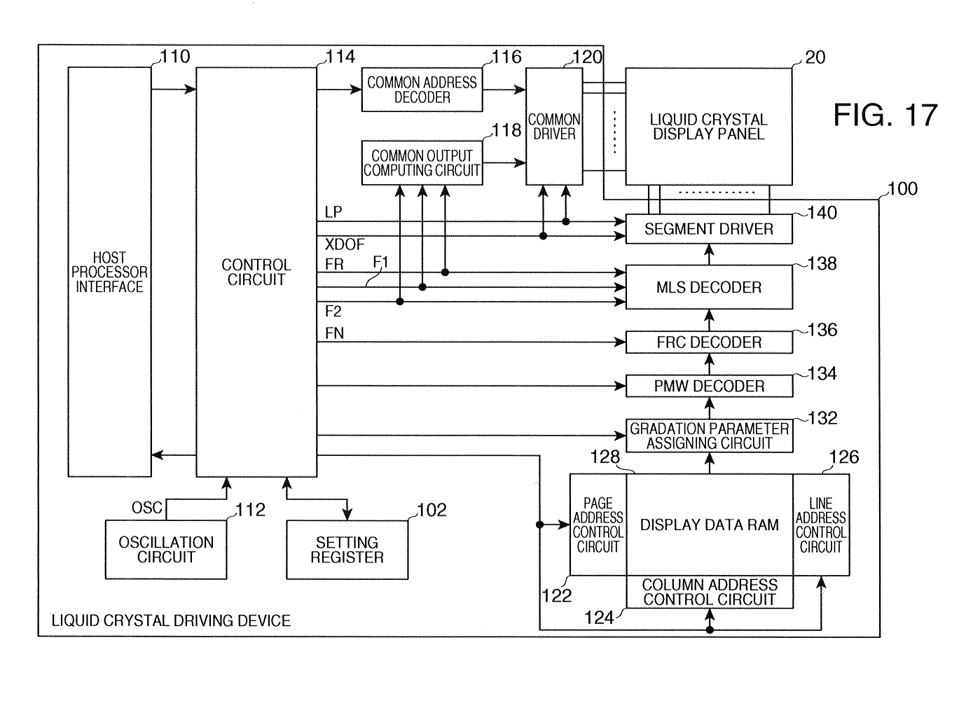

FIG. 17 shows a block diagram of a configuration example of the liquid crystal driving device 100 in the present embodiment. While description is made in FIG. 17 assuming that the liquid crystal driving device 100 performs the MLS driving of the four-line simultaneous selection, the present embodiment is not limited by the number of the simultaneously selected lines. It should be noted that, in FIG. 17, components identical to those in FIG. 1 are designated with the same reference numerals and description thereof is omitted as appropriate.

The liquid crystal driving device 100 includes a setting register 102, a host processor interface 110, an oscillation circuit 112, a control circuit 114, a common address decoder 116, a common output computing circuit 118, a common driver 120, a pager address control circuit 122, a column address control circuit 124, a line address control circuit 126, a display data RAM 128, a gradation parameter assigning circuit 132, a PWM decoder 134, an FRC decoder 136, an MLS decoder 138, and a segment driver 140. The driving portion in the present embodiment is formed to include the common driver 120 and the segment driver 140, and may also include at least one of the common address decoder 116, the common output computing circuit 118, the gradation parameter assigning circuit 132, the PWM decoder 134, the FRC decoder 136, and the MLS decoder 138.

The setting register 102 has a plurality of registers in which control data for controlling the liquid crystal driving device 100 is set. Each of the registers included by the setting register 102 is accessed by the host processor 30 through the host processor interface 110. The control data specified by the host processor 30 is set in the associated register through the control circuit 114.

The host processor interface 110 performs the input interface processing of an input signal input from the host processor 30 through an input terminal or an input/output terminal included by the liquid crystal driving device 100 or the output interface processing of an output signal output to the host processor 30 through an output terminal or the input/output terminal included by the liquid crystal driving device 100.

The oscillation circuit 112 produces, with oscillating operation, an oscillation clock OSC which serves as a reference of a display timing signal produced by the liquid crystal driving device 100. For example, the control circuit 114 produces a plurality of types of display timing signals based on the oscillation clock OSC. The control circuit 114 produces a control signal for controlling each of the portions of the liquid crystal driving device 100 such as the common address decoder 116.

The common address decoder 116 decodes the common addresses produced in the control circuit 114 and associated with the plurality of common electrodes simultaneously selected in the MLS driving. The result of the decode is output to the common driver 120. The common addresses are assigned for each of the pluralities of the common electrodes simultaneously selected, and in performing the MLS driving, the common addresses are specified to select the associated common electrodes.

The common output computing circuit 118 controls the output level of the common output based on the liquid crystal alternating signal FR produced in the control circuit 114, and the field signals F1 and F2 for identifying the MLS driving pattern.

The common driver 120 controls the selection/non-selection of the common output based on the result of the decode in the common address decoder 116, and outputs the output level produced in the common output computing circuit 118 as the selected common output.

The pager address control circuit 122 controls the page address for the access of the display data input from the host processor 30 through the host processor interface 110 to the display data RAM 128. The pager address is defined by using the bus width of the display data input from the host processor 30 as the access unit.

The column address control circuit 124 controls the column address for the access of the display data input from the host processor 30 through the host processor interface 110 to the display data RAM 128. The column address is defined in association with the segment electrode of the liquid crystal display panel 20.

The line address control circuit 126 controls the line address for specifying the read-out line of the display data saved in the display data RAM 128. The line address is defined in association with the common electrode of the liquid crystal display panel 20.

The display data RAM 128 has storage regions in which the display data for each of the pixels is stored in association with the arrangement of the pixels of the liquid crystal display panel 20. Each of the storage regions is specified by the page address and the column address. Thus, the display data is written to the region specified by the page address and the column address in the display data RAM 128. On the other hand, the display data is read out on a line-by-line basis from the display data RAM 128.

The gradation parameter assigning circuit 132 assigns the display data of two (=N) bits per dot to the gradation parameter of 5 (=M) bits. In the present embodiment, the gradation parameter is assigned to the display data in association with the predetermined gradation level (0, 1), (1, 0). However, which display data (gradation level) is assigned to which gradation parameter may be specified by the control data set in the setting register 102 by the host processor 30. In any case, the assigning information of the gradation parameter is input to the gradation parameter assigning circuit 132 from the control circuit 114.

The PWM decoder 134 performs the PWM decode as described above based on higher-order bits of the gradation parameter assigned by the gradation parameter assigning circuit 132 to produce the PWM data. More specifically, the PWM decoder 134 determines which divided period within the sub-selection period is used to perform the gradation display based on the higher-order two bits of the gradation parameter (selects the narrow-width period or the wide-width period). The number, the lengths and the like of the divided periods provided within the sub-selection period can be specified by the control data set in the setting register 102 by the host processor 30, and the PWM setting information is input to the PWM decoder 134 from the control circuit 114.

The FRC decoder 136 performs the FRC decode as described above based on lower-order bits of the gradation parameter assigned by the gradation parameter assigning circuit 132 to produce the FRC data (selects the FRC pattern). More specifically, the FRC decoder 136 produces the FRC data for specifying turn-on or turn-off for each of the frames with the display pattern indicated by the FRC pattern in association with the PWM data based on the lower-order three bits of the gradation parameter. The FRC pattern, the frame number and the like are previously saved or produced in the control circuit 114, and the FRC control information is input to the FRC decoder 136 from the control circuit 114.

The MLS decoder 138 decodes the FRC data (in a broad sense, the display data or the gradation parameter in association with the display data) and the display timing signal for performing the MLS driving produced in the control circuit 114 to produce the result of the decode in accordance with the result of the given MLS computing. More specifically, the MLS decoder 138 controls the output level of the segment output based on the FRC data, the liquid crystal alternating signal FR produced by the control circuit 114, and the field signals F1 and F2. The result of the decode of the MLS decoder 138 is output to the segment driver 140.

The segment driver 140 outputs the output level decoded by the MLS decoder 138 to the segment electrode based on the decode result of the MLS decoder 138. It should be noted that the segment driver 140 can perform control such that the given output level is output to the segment electrode to turn off the display regardless of the decode result of the MLS decoder 138 with a display off signal XDOF produced in the control circuit 114. In the present embodiment, with the display off signal XDOF, the output level to achieve the same potential as that of the common electrode is output to the segment electrode to turn off the display.

In the liquid crystal driving device 100 of the configuration as described above, in synchronization with a latch pulse LP output for each one horizontal scanning period, the common driver 120 outputs a selection pulse to the plurality of common electrodes simultaneously selected, and the segment driver 140 can output the output level decoded on the basis of the display data and the display timing signal to each of the segment electrodes.

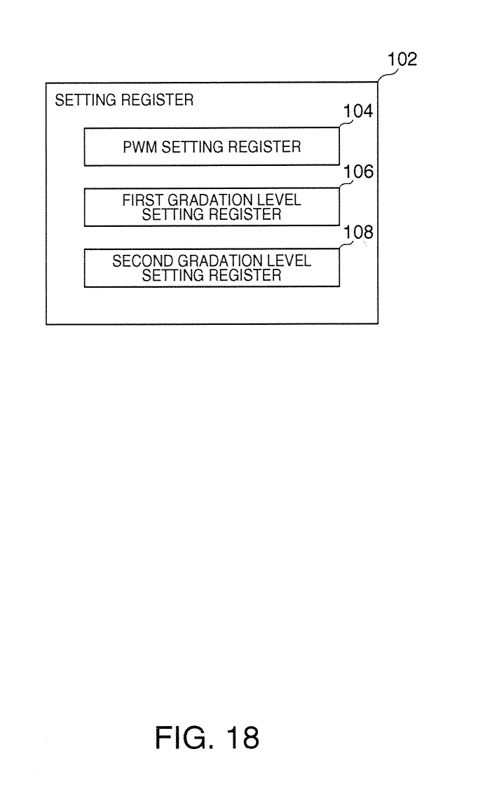

FIG. 18 shows the outlines of the configuration of the setting register 102 shown in FIG. 17. In FIG. 18, components identical to those in FIG. 17 are designated with the same reference numerals and description thereof is omitted as appropriate.

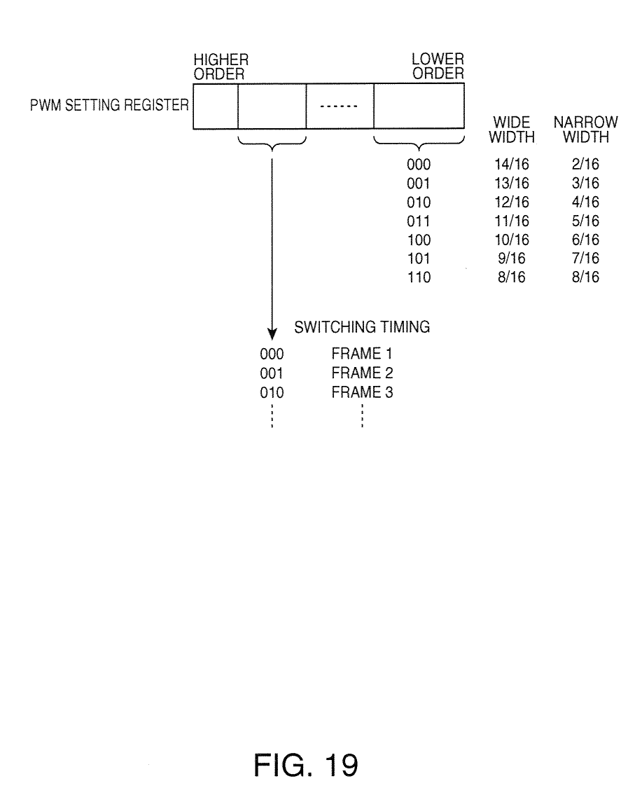

FIG. 19 shows an explanatory diagram of a PWM setting register in FIG. 18.

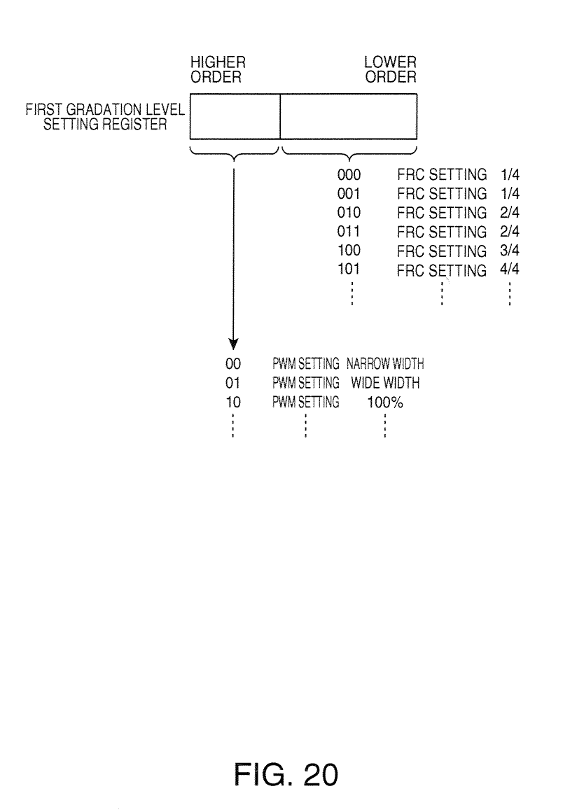

FIG. 20 shows an explanatory diagram of a first gradation level setting register in FIG. 18. While the first gradation level setting register is described in FIG. 20, a second gradation level setting register is similar to the first gradation level setting register.

The setting register 102 includes the PWM setting register 104, the first gradation level setting register 106, and the second gradation level setting register 108.

In the PWM setting register 104 shown in FIG. 19, the control data in association with the PWM setting information is set. A portion of the control data is associated with the timing at which the order of the wide-width period and the narrow-width period is reversed back and force. For example, when a portion of the control data is set to “001,” control is performed such that the order of the wide-width period and the narrow-width period is reversed back and forth for each of groups of two frames.

Another portion of the control data is associated with the length of the wide-width period and the length of the narrow-width period. For example, when the other portion of the control data is set to “000”, the wide-width period is set to the period corresponding to 14 pulses out of the 16 pulses ( 14/16), and the narrow-width period is set to the period corresponding to two pulses out of the 16 pulses ( 2/16). Alternatively, for example when the other portion of the control data is set to “100,” the wide-width period is set to the period corresponding to 10 pulses out of the 16 pulses ( 10/16), and the narrow-width period is set to the period corresponding to six pulses out of the 16 pulses ( 6/16).

Such PWM setting information in association with the control data set in the PWM setting register 104 is output to the control circuit 114 and the PWM decoder 134.

In the first gradation level setting register 106 shown in FIG. 20, the control data in association with the concentration setting information of the gradation level (0, 1) is set. The higher-order two bits of the control data (a portion of the control data) specify which of the narrow-width period, the wide-width period, and 100% (both of the narrow-width period and the wide-width period) in the divided period of the PWM to be assigned the concentration setting of the gradation level (0, 1). For example, when “01” is set to the higher-order two bits of the control data, the concentration setting of the gradation level (0, 1) is set to the wide-width period.

The lower-order three bits of the control data (another portion of the control data) specify which gradation level of the FRC is assigned the concentration setting of the gradation level (0, 1). For example, when the lower-order three bits of the control data are set to “000,” the concentration setting of the gradation level (0, 1) is assigned to the gradation level ¼ of the FRC. Alternatively, for example when the lower-order three bits of the control data is set to “011,” the concentration setting of the gradation level (0, 1) is assigned to the gradation level ⅔ of the FRC.

Such first gradation level setting information in association with the control data set in the first gradation level setting register 106 is output to the control circuit 114 and the gradation parameter assigning circuit 132.

Similarly, the control data in association with the concentration setting information of the gradation level (1, 0) is set in the second gradation level setting register 108, not shown. The higher-order two bits of the control data specify which of the narrow-width period, the wide-width period, and 100% (both of the narrow-width period and the wide-width period) in the divided period of the PWM is assigned the concentration setting of the gradation level (1, 0). For example, when “01” is set to the higher-order two bits of the control data, the concentration setting of the gradation level (1, 0) is set to the wide-width period.

The lower-order three bits of the control data specify which gradation level of the FRC is assigned the concentration setting of the gradation level (1, 0). For example, when the lower-order three bits of the control data are set to “000,” the concentration setting of the gradation level (1, 0) is assigned to the gradation level ¼ of the FRC. Alternatively, for example when the lower-order three bits of the control data is set to “011,” the concentration setting of the gradation level (1, 0) is assigned to the gradation level ⅔ of the FRC.

Such second gradation level setting information in association with the control data set in the second gradation level setting register 108 is output to the control circuit 114 and the gradation parameter assigning circuit 132.

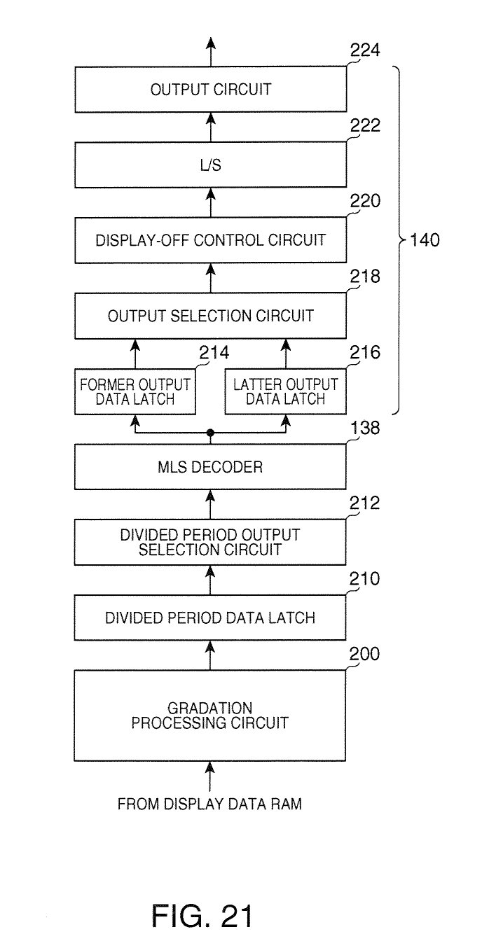

FIG. 21 shows an example of a block diagram of main portions constituting the liquid crystal driving device 100 in FIG. 17. FIG. 21 represents the block diagram of a configuration example per segment output. In FIG. 21, components identical to those in FIG. 17 are designated with the same reference numerals and description thereof is omitted as appropriate.

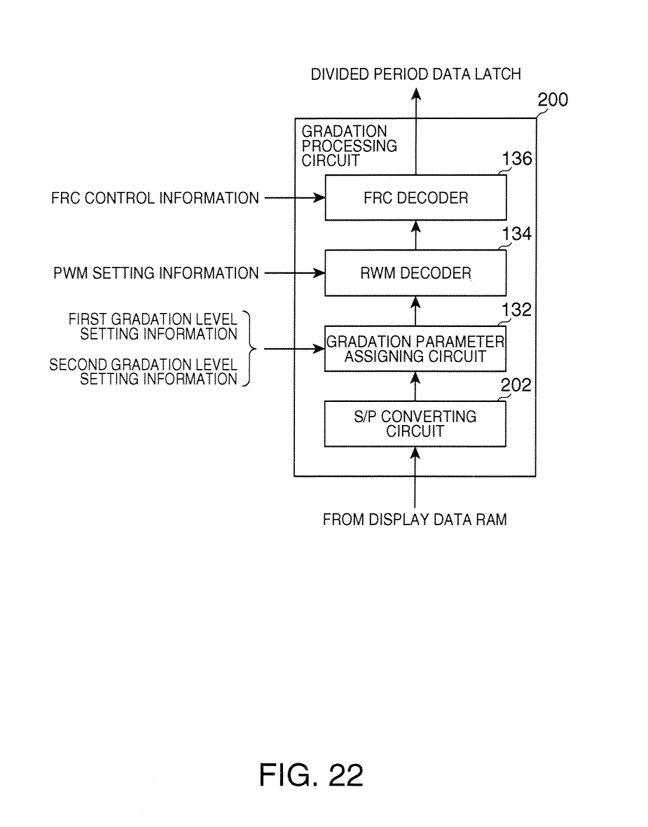

FIG. 22 shows a block diagram of a configuration example of a gradation processing circuit in FIG. 21. In FIG. 22, components identical to those in FIG. 17 are designated with the same reference numerals and description thereof is omitted as appropriate.

As shown in FIG. 21, the liquid crystal driving device 100 includes the gradation processing circuit 200, a divided period data latch 210, a divided period output selection circuit 212, the MLS decoder 138, and the segment driver 140. The segment driver 140 includes a former output data latch (first output data latch) 214, a latter output data latch (second output data latch) 216, an output selection circuit 218, a display-off control circuit 220, a level shifter (L/S) 222, and an output circuit 224. As shown in FIG. 22, the gradation processing circuit 200 includes a serial/parallel converting circuit (hereinafter referred to as an S/P converting circuit) 202, the gradation parameter assigning circuit 132, the PWM decoder 134, and the FRC decoder 136. Each of the former output data latch 214, the latter output data latch 216, the output selection circuit 218, the display-off control circuit 220, the level shifter 222, and the output circuit 224 is controlled by a control signal, not shown, from the control circuit 114.

The gradation processing circuit 200 reads out the four lines of the display data as serial data of one bit from the display data RAM 128 and converts it into parallel data of bit numbers (=two) per dot in the S/P converting circuit 202. The control circuit 114 supplies the control signal to the gradation processing circuit 200 or the like in accordance with the timing at which the display data for each dot is input serially.

The gradation parameter assigning circuit 132 assigns the display data for each dot to the gradation parameter of five bits previously set in the first gradation level setting register 106 or the second gradation level setting register 108 based on the gradation level setting information from the control circuit 114 at the time of the gradation level (0, 1) or the gradation level (1, 0). Then, the PWM decoder 134 produces the PWM data in association with the divided period specified by the higher-order two bits assigned in the gradation parameter assigning circuit 132 as described above on the basis of the PWM setting information from the control circuit 114. The PWM data is input to the FRC decoder 136, and the FRC decoder 136 produces the FRC data in association with the concentration setting of the FRC specified by the lower-order three bits of the gradation parameter as described above.

The divided period data latch 210 includes data latches for supporting the simultaneously selected four lines. The data latch for each of the lines includes a narrow-width period data latch (first divided period data latch) and a wide-width period data latch (second divided period data latch). The FRC data assigned to the narrow-width period in the gradation processing circuit 200 is latched in the narrow-width period data latch. The FRC data assigned to the wide-width period in the gradation processing circuit 200 is latched in the wide-width period data latch. Thus, the FRC data required for the MLS decode is saved in the narrow-width period data latches and the wide-width period data latches for supporting the four lines.

The divided period output selection circuit 212 outputs the FRC data latched in the narrow-width period data latch or the FRC data latched in the wide-width period data latch in synchronization with the timing at which the narrow-width period and the wide-width period are switched.

In response to the FRC data for the four lines sequentially output from the divided period output selection circuit 212, the MLS decoder 138 outputs the result of the MLS decode in accordance with the result of the given MLS computing as described above based on the selection pattern of the simultaneously selected common electrodes.

One of the result of the MLS decode for the narrow-width period or the result of the MLS decode for the wide-width period output in the first half of the sub-selection period is latched in the former output data latch 214, out of the result of the decode from the MLS decoder 138. One of the result of the MLS decode for the narrow-width period or the result of the MLS decode for the wide-width period output in the second half of the sub-selection period is latched in the latter output data latch 216, out of the result of the decode from the MLS decoder 138. The output selection circuit 218 outputs the result of the decode latched in the former output data latch 214 or the result of the decode latched in the latter output data latch 216 in synchronization with the timing at which the narrow-width period and the wide-width period are switched. The output selection circuit 218 allows the narrow-width period and the wide-width period to be switched back and forth at the switching timing set in the PWM setting register 104 in FIG. 19.

The display-off control circuit 220 performs the control of outputting, to the segment electrode, the output level to achieve the same potential as that of the associated common electrode to turn off the display regardless of the result of the decode of the MLS decoder 138 based on the display-off signal XDOF from the control circuit 114.

The level shifter 222 performs the conversion into the level of the driving voltage of the plurality of levels for the segment electrode shown in FIG. 3 based on the outputs from the output selection circuit 218 and the display-off control circuit 220. The output circuit 224 applies the driving voltage of the level converted by the level shifter 222 to the segment electrode in synchronization with the driving timing indicated by the control circuit 114.

As described above, in the present embodiment, the display data of the two bits is assigned to the gradation parameter of the five bits in performing the MLS driving. Then, the gradation display with the PWM is performed by using the divided period selected on the basis of that gradation parameter, and the concentration setting of the FRC selected on the basis of that gradation parameter is allowed, so that the degree of flexibility in the concentration settings for the halftones can be improved in the gradation display.

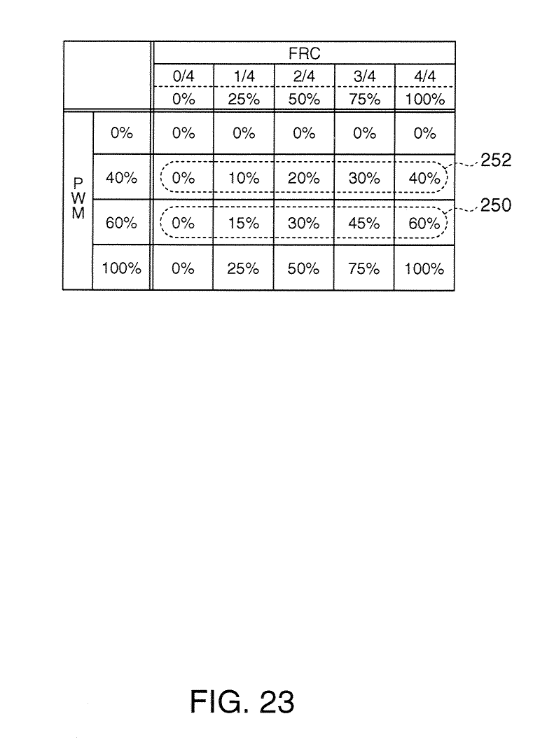

FIG. 23 shows an explanatory diagram of the advantages of the present embodiment. In FIG. 23, the vertical axis represents the concentration settings for the halftones with the PWM and the horizontal axis represents the concentration settings for the halftones with the FRC. In addition, FIG. 23 shows the concentration settings with percentages as the unit. It should be noted that the description with FIG. 23 is made assuming that the gradation levels in the FRC are only 0/4, 1/4, 2/4, 3/4, and 4/4 for simplifying the description.

For example, when the concentration setting in the PWM is set to 60% for one of the gradation levels of the halftones out of the four gradations, the gradation display of one of 0%, 15%, 30%, 45%, and 60% (the portion of a range 250 in FIG. 23) is enabled when it is combined with the concentration settings of in FRC. However, in the prior art, even when the PWM scheme is combined with the FRC scheme in the MLS driving method, the higher-order bit of the display data is associated with the wide-width period and the lower-order bit is associated with the narrow-width period, for example as in Patent Document 2, so that the gradation display can only be performed at one of 0%, 10%, 20%, 30%, and 40% (the portion of a range 252 in FIG. 23) with the concentration setting in the PWM of 40% (=100%-60%) in the narrow-width period, and the degree of flexibility in the concentration settings is limited for the other gradation level of the halftones.

In contrast, according to the present embodiment, since the wide-width period and the narrow-width period can be specified regardless of the display data as described above, selection can be made from any of the range 250 in FIG. 23 for each of the wide-width period and the narrow-width period or selection can be made from any of the range 252 in FIG. 23 for each of the wide-width period and the narrow-width period. In the example of FIG. 23, selection can be made from the range 250 in FIG. 23 for each of the two gradation levels out of the four gradations, or selection can be made from the range 252 in FIG. 23 for each of the two gradation levels, regardless of the display data. Thus, according to the present embodiment, the degree of flexibility in the concentration settings for the halftones can be improved in performing the gradation display with the PWM scheme and the FRC scheme within the same frame.

### 5. Modification

### 5.1 First Modification

The configuration of the liquid crystal driving device 100 in the present embodiment is not limited to the configuration shown in FIG. 17, FIG. 20, and FIG. 21. The present embodiment employs the configuration in which the display data for the four lines per segment output is subjected to the PWM decode, the FRC decode and the like in a serial manner. In a first modification of the present embodiment, however, a liquid crystal driving device has the configuration in which display data for each line per segment output is subjected to the PWM decode and the FRC decode in a parallel manner. In the following, an example of the configuration of the liquid crystal driving device in the first modification will be described. The liquid crystal driving device in the first modification has a similar configuration to that in FIG. 17.

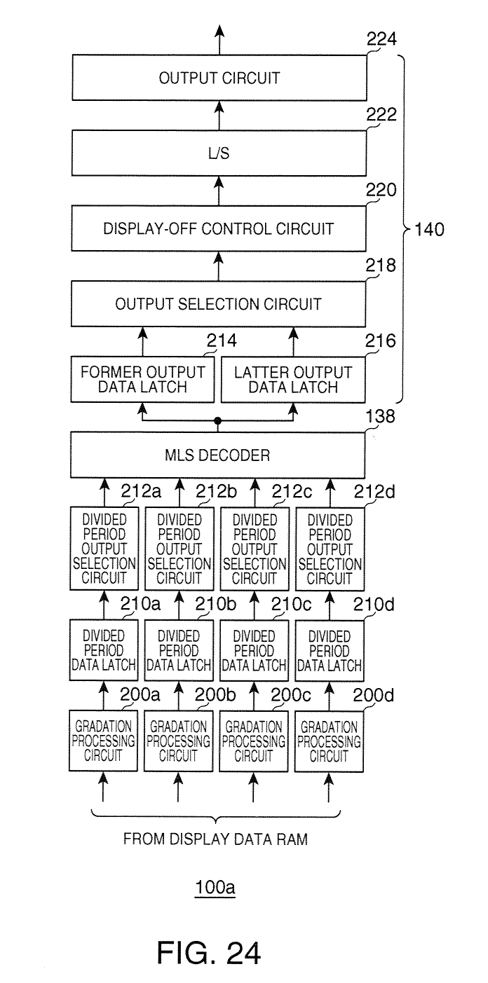

FIG. 24 shows an example of a block diagram of main portions constituting the liquid crystal driving device in the first modification of the present embodiment. FIG. 24 shows the block diagram of the example of the configuration per segment output. In FIG. 24, portions identical to those in FIG. 21 are designated with the same reference numerals and description thereof is omitted as appropriate.

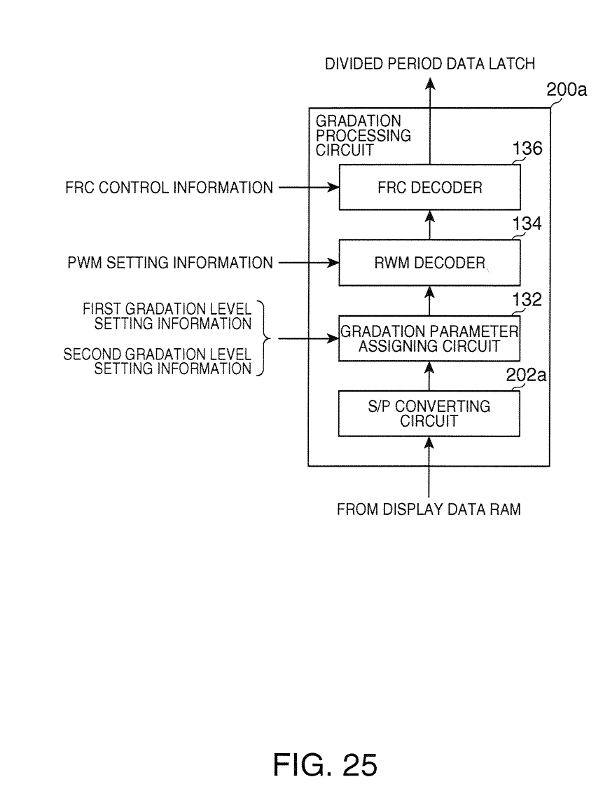

FIG. 25 shows a block diagram of an example of the configuration of a gradation processing circuit in FIG. 24. In FIG. 25, portions identical to those in FIG. 22 are designated with the same reference numerals and description thereof is omitted as appropriate.

The configuration of the liquid crystal driving device 100a in the first modification differs from the configuration of the liquid crystal driving device 100 shown in FIG. 21 in that the former has the configuration in which the display data for each line per segment output is subjected to the PWM decode, the FRC decode and the like in a parallel manner. Thus, the liquid crystal driving device 100a has gradation processing circuits 200a, 200b, 200c, and 200d, divided period data latches 210a, 210b, 210c, and 210d, and divided period output selection circuits 212a, 212b, 212c, and 212d, instead of the gradation processing circuit 200, the divided period data latch 210, and the divided period output selection circuit 212 in the liquid crystal driving device 100.

The gradation processing circuit 200a, the divided data latch 210a, and the divided period output selection circuit 212a are provided in association with the first line out of simultaneously selected four lines. The gradation processing circuit 200b, the divided data latch 210b, and the divided period output selection circuit 212b are provided in association with the second line out of the simultaneously selected four lines. The gradation processing circuit 200c, the divided data latch 210c, and the divided period output selection circuit 212c are provided in association with the third line out of the simultaneously selected four lines. The gradation processing circuit 200d, the divided data latch 210d, and the divided period output selection circuit 212d are provided in association with the fourth line out of the simultaneously selected four lines. Each of the gradation processing circuits 200a, 200b, 200c, and 200d has the similar configuration. Each of the divided period data latches 210a, 210b, 210c, and 210d has the similar configuration. Each of the divided period output selection circuits 212a, 212b, 212c, and 212d has the similar configuration. In the following, the gradation processing circuit 200a, the divided data latch 210a, and the divided period output selection circuit 212a will be described.

The gradation processing circuit 200a reads out display data of two bits as serial data of one bit from the display data RAM 128 and converts it into parallel data of bit numbers (=two) per dot in the S/P converting circuit 202a. The control circuit 114 supplies a control signal to the gradation processing circuit 200a or the like in accordance with the timing at which the display data for each dot is input serially.

The gradation parameter assigning circuit 132 assigns the display data for each dot to the gradation parameter of five bits previously set in the first gradation level setting register 106 or the second gradation level setting register 108 based on the gradation level setting information from the control circuit 114 at the time of the gradation level (0, 1) or the gradation level (1, 0). Then, the PWM decoder 134 produces the PWM data in association with the divided period specified by the higher-order two bits assigned in the gradation parameter assigning circuit 132 as described above on the basis of the PWM setting information from the control circuit 114. The PWM data is input to the FRC decoder 136, and the FRC decoder 136 produces the FRC data in association with the concentration setting of the FRC specified by the lower-order three bits of the gradation parameter as described above.

The divided period data latch 210a includes a narrow-width period data latch (first divided period data latch) and a wide-width period data latch (second divided period data latch). The FRC data assigned to the narrow-width period in the gradation processing circuit 200a is latched in the narrow-width period data latch. The FRC data assigned to the wide-width period in the gradation processing circuit 200a is latched in the wide-width period data latch.

The divided period output selection circuit 212a outputs the FRC data latched in the narrow-width period data latch or the FRC data latched in the wide-width period data latch in synchronization with the timing at which the narrow-width period and the wide-width period are switched.

In response to the FRC data for the four lines output from the divided period output selection circuits 212a to 212d, the MLS decoder 138 outputs the result of the MLS decode in accordance with the result of the given MLS computing as described above based on the selection pattern of the simultaneously selected common electrodes. In response to the result of the MLS decode from the MLS decoder 138, the liquid crystal driving device 100a performs the control similar to that in the present embodiment to apply the driving voltage to the segment electrode.

The liquid crystal driving device 100a in the first modification as described above can be applied instead of the liquid crystal driving device 100 in the electronic instrument 10 shown in FIG. 1.

As described above, according to the first modification, the segment electrode can be driven without accelerating the operation clock within the liquid crystal driving device, and lower power consumption can be achieved in addition to the advantages of the present embodiment.

### 5.2 Second Modification

While the liquid crystal driving device is provided outside the liquid crystal display panel 20 in the present embodiment and the first modification thereof, the present invention is not limited thereto.

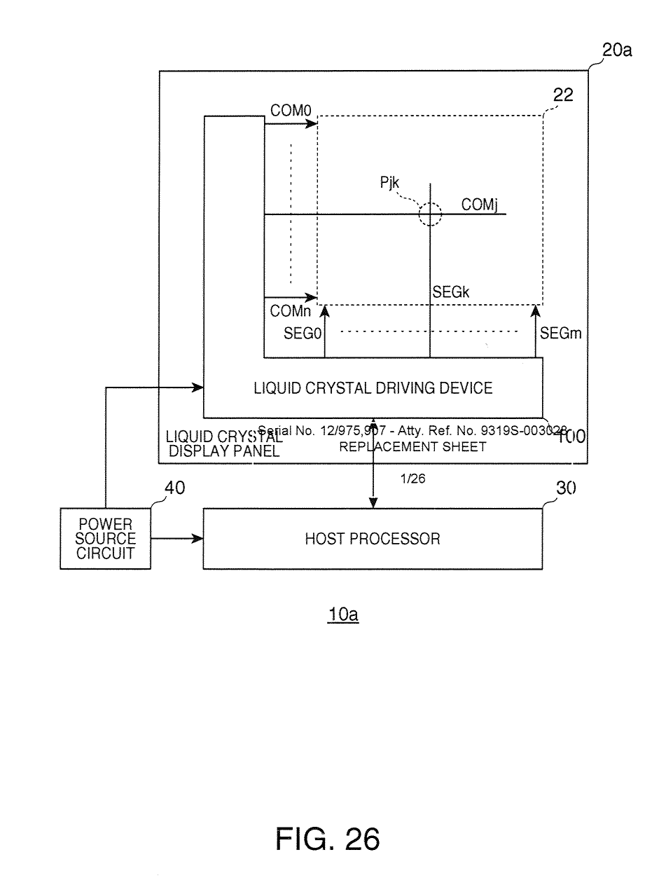

FIG. 26 shows a block diagram of an example of the configuration of an electronic instrument in a second modification of the present embodiment. In FIG. 26, portions identical to those in FIG. 1 are designated with the same reference numerals and description thereof is omitted as appropriate.

The configuration of the electronic instrument 10a in the second modification differs from the configuration of the electronic instrument 10 shown in FIG. 1 in that a liquid crystal display device 100 (or a liquid crystal driving device 100a) is mounted on a glass substrate on which a liquid crystal display panel 20a is formed.

The liquid crystal display panel 20a is a display panel of a simple matrix type. The liquid crystal display panel 20a is formed by sealing-in a plurality of common electrodes COM0 to COMn and a plurality of segment electrodes SEG0 to SEGm formed of a transparent electrode and placed to intersect each other, an orientation film, a liquid crystal and the like between a pair of transparent glass substrates in a dot forming region 22. In the liquid crystal display panel 20a, dots are formed in correspondence with the intersecting regions of the common electrodes and the segment electrodes. For example, a dot Pjk is formed in correspondence with the intersecting region of a common electrode COMj and a segment electrode SEGk.

The liquid crystal driving device 100 (or the liquid crystal driving device 100a) is electrically connected to the common electrodes and the segment electrodes of the liquid crystal display panel 20a through a conductive member formed on the glass substrate. The host processor 30 and the power source circuit 40 are also connected electrically to the liquid crystal driving device 100 through the conductive member formed on the glass substrate.

The electronic instrument 10a having such a configuration can also be applied to an instrument similar to the electronic instrument 10.

The driving method of the electro optical device, the driving device of the electro optical device, the electro optical device, the electronic instrument and the like according to the present invention have been described on the basis of the abovementioned embodiment and the modification thereof. However, the present invention is not limited to the abovementioned embodiment and the modification thereof but can be implemented in various aspects without departing from the spirit or scope thereof. For example, the following modifications are possible.

(1) In the abovementioned embodiment and the modification thereof, description has been made by using the liquid crystal display panel as an example of the electro optical device. However, the present invention is not limited thereto. For example, the present invention can be applied to a driving device for driving another display panel such as an organic EL display panel and a plasma display.

(2) In the abovementioned embodiment and the modification thereof, description has been made by using the MLS driving in which the four lines are simultaneously selected as an example. However, the present invention is not limited by the number of the lines simultaneously selected.

(3) In the abovementioned embodiment and the modification thereof, description has been made of the configurations of the liquid crystal driving device shown in FIG. 17, FIG. 21, FIG. 22, FIG. 24, and FIG. 25. However, the present invention is not limited to those configurations.

What is claimed is:

1. A driving method of driving an electro optical device having a plurality of common electrodes and a plurality of segment electrodes intersecting each other with a Multi Line Selection driving method, comprising:
a gradation parameter assigning step of assigning display data of N bits (N is an integer equal to or larger than two) in association with each dot provided in an intersecting region of each of the common electrodes and each of the segment electrodes to a gradation parameter of M bits (N<M, M is an integer equal to or larger than three), and
a driving step of applying a driving voltage in accordance with a result of Multi Line Selection computing on a display pattern indicated by a Frame Rate Control pattern selected on the basis of part of the gradation parameter to the plurality of segment electrodes in a divided period in association with at least part of the gradation parameter assigned at the gradation parameter assigning step out of a plurality of divided periods provided by dividing a sub-selection period provided by dividing a selection period of a plurality of common electrodes simultaneously selected.

2. The driving method of the electro optical device according to claim 1,
the driving step includes:
a first divided period driving step of applying a driving voltage in accordance with a result of Multi Line Selection computing on a display pattern indicated by a first Frame Rate Control pattern selected on the basis of part of the gradation parameter to the plurality of segment electrodes in a first divided period in association with part of the gradation parameter assigned at the gradation parameter assigning step out of the plurality of divided periods; and
a second divided period driving step of applying a driving voltage in accordance with a result of Multi Line Selection computing on a display pattern indicated by a second Frame Rate Control pattern selected on the basis of part of the gradation parameter to the plurality of segment electrodes in a second divided period in association with part of the gradation parameter assigned at the gradation parameter assigning step out of the plurality of divided periods.

3. The driving method of the electro optical device according to claim 2,
the first divided period or the second divided period is selected on the basis of a higher-order bit of the gradation parameter.

4. The driving method of the electro optical device according to claim 3,
a driving voltage in accordance with a result of Multi Line Selection computing on a display pattern indicated by a Frame Rate Control pattern selected on the basis of a lower-order bit of the gradation parameter is applied to the plurality of segment electrodes.

5. The driving method of the electro optical device according to claim 3,
one of the first divided period or the second divided period provided by dividing the sub-selection period into two is selected on the basis of higher-order two bits of the gradation parameter.

6. The driving method of the electro optical device according to claim 2,
the order of the first divided period and the second divided period can be switched within the sub-selection period.

7. The driving method of the electro optical device according to claim 6,
the order of the first divided period and the second divided period within the sub-selection period is set to be reversed for each segment output.

8. The driving method of the electro optical device according to claim 6,
the order of the first divided period and the second divided period is changed for each predetermined period.

9. A driving method of an electro optical device of driving an electro optical device having a plurality of common electrodes and a plurality of segment electrodes intersecting each other with a Multi Line Selection driving method, comprising:
a gradation parameter assigning step of assigning display data of N bits (N is an integer equal to or larger than two) in association with each dot provided in an intersecting region of each of the common electrodes and each of the segment electrodes to a gradation parameter of M bits (N<M, M is an integer equal to or larger than three), and
a driving step of applying a driving voltage in accordance with a result of Multi Line Selection computing on a signal subjected to gradation processing with Pulse Width Modulation and Frame Rate Control on the basis of part of the gradation parameter to the plurality of segment electrodes in a sub-selection period provided by dividing a selection period of a plurality of common electrodes simultaneously selected.

10. The driving method of the electro optical device according to claim 9,
the driving step includes:
a Pulse Width Modulation decode step of selecting a divided period in association with at least part of the gradation parameter assigned at the gradation parameter assigning step out of a plurality of divided periods provided by dividing the sub-selection period;
Frame Rate Control decode step of producing Frame Rate Control data based on a Frame Rate Control pattern selected on the basis of part of the gradation parameter; and
a Multi Line Selection decode step of performing given Multi Line Selection computing on the Frame Rate Control data produced at the Frame Rate Control decode step in the divided period selected at the Pulse Width Modulation decode step, and
a driving voltage in accordance with a result of the Multi Line Selection computing at the Multi Line Selection decode step is applied to the plurality of segment electrodes.

11. The driving method of the electro optical device according to claim 1,
the electro optical device is a liquid crystal display device.

12. A driving device of an electro optical device of driving an electro optical device having a plurality of common electrodes and a plurality of segment electrodes intersecting each other with a Multi Line Selection driving method, comprising:
a gradation parameter assigning portion assigning display data of N bits (N is an integer equal to or larger than two) in association with each dot provided in an intersecting region of each of the common electrodes and each of the segment electrodes to a gradation parameter of M bits (N<M, M is an integer equal to or larger than three);
a Pulse Width Modulation decoder selecting a divided period in association with at least part of the gradation parameter assigned by the gradation parameter assigning portion out of a plurality of divided periods provided by dividing a sub-selection period provided by dividing a selection period of a plurality of common electrodes simultaneously selected;
a Frame Rate Control decoder producing Frame Rate Control data based on an Frame Rate Control pattern selected on the basis of part of the gradation parameter in the divided period selected by the Pulse Width Modulation decoder;
an Multi Line Selection decoder performing given Multi Line Selection computing on the Frame Rate Control data produced by the Frame Rate Control decoder in the divided period selected by the Pulse Width Modulation decoder; and
a driving portion applying a driving voltage in accordance with a result of the Multi Line Selection computing performed by the Multi Line Selection decoder to the plurality of segment electrodes.

13. The driving device of the electro optical device according to claim 12, comprising:
a first output data latch latching the Frame Rate Control data in a first divided period selected by the Pulse Width Modulation decoder out of the plurality of periods;
a second output data latch latching the Frame Rate Control data in a second divided period selected by the Pulse Width Modulation decoder out of the plurality of periods; and
an output selection circuit outputting a signal latched in the first output data latch or a signal latched in the second output data latch to the driving portion.

14. An electro optical device comprising the driving device according to claim 12.

15. An electronic instrument comprising the driving device according to claim 12.

16. The driving method of the electro optical device according to claim 9,
the electro optical device is a liquid crystal display device.
